(19) United States
(12) Patent Application Publication
(10) Pub. No.: US 2023/0232385 A1
(43) Pub. Date: Jul. 20, 2023

(54) COMMUNICATION APPARATUS AND COMMUNICATION METHOD FOR RESOURCE UNIT ALLOCATION SIGNALLING

(71) Applicant: Panasonic Intellectual Property Corporation of America, Torrance, CA (US)

(72) Inventors: Lei HUANG, Singapore (SG); Yoshio URABE, Nara (JP); Rojan CHITRAKAR, Singapore (SG)

(21) Appl. No.: 18/002,451

(22) PCT Filed: May 12, 2021
(86) PCT No.: PCT/SG2021/050261

§ 371 Date: Dec. 19, 2022

(30) Foreign Application Priority Data
Jun. 26, 2020 (SG) 10202006197X

(51) Int. Cl. H04W 72/0453

(52) U.S. Cl. CPC H04W 72/0453; H04W 84/12

(57) ABSTRACT

The present disclosure provides communication apparatus and communication method for resource unit allocation signalling. The communication apparatus comprises circuitry, which, in operation, generates a physical layer protocol data unit (PPDU) comprising two signal field content channels in each 80 MHz frequency segment, each of the two signal field content channels comprising a plurality of resource unit (RU) allocation subfields, wherein a value of each of the plurality of RU allocation subfields is able to indicate sizes of component RUs of a large-size RU combination; and a transmitter, which, in operation, transmits the generated PPDU.

### TECHNICAL FIELD

The present disclosure relates to communication apparatuses and methods for control signalling, and more particularly to communication apparatuses and methods for resource unit allocation signalling in extremely high throughput wireless local area network (EHT WLAN).

### BACKGROUND

In the standardization of next generation wireless local area network (WLAN), a new radio access technology having backward compatibilities with IEEE 802.11 a/b/g/n/ac/ax technologies has been discussed in the IEEE 802.11 Working Group and is named IEEE 802.11be Extremely High Throughput (EHT) WLAN.

In 802.11be EHT WLAN, in order to improve spectral efficiency and provide significant peak throughput and capacity increase over 802.11ax high efficiency (HE) WLAN, it has been proposed to increase maximum channel bandwidth to 320 MHz and allow multiple contiguous and non-contiguous RUs assigned to a single STA.

However, there has been no much discussion on communication apparatuses and methods on efficient resource unit (RU) allocation signalling support for assigning multiple RUs to a single STA in an EHT PPDU having a bandwidth up to 320 MHz.

There is thus a need for communication apparatuses and methods that provide feasible technical solutions for RU allocation signalling in the context of EHT WLAN. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for resource unit allocation signalling in context of EHT WLAN.

In a first aspect, the present disclosure provides a communication apparatus comprising circuitry, which, in operation, generates a physical layer protocol data unit (PPDU) comprising two signal field content channels in each 80 MHz frequency segment, each of the two signal field content channels comprising a plurality of resource unit (RU) allocation subfields, wherein a value of each of the plurality of RU allocation subfields is able to indicate sizes of component RUs of a large-size RU combination; and a transmitter, which, in operation, transmits the generated PPDU.

In a second aspect, the present disclosure provides a communication method comprising generating a PPDU comprising two signal field content channels in each 80 MHz frequency segment, each of the two signal field content channels comprising a plurality of RU allocation subfields, wherein a value of each of the plurality of RU allocation subfields is able to indicate sizes of component RUs of a large-size RU combination; and transmitting the generated PPDU.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1A depicts a schematic diagram of uplink and downlink single-user (SU) multiple input multiple output (MIMO) communication between an access point (AP) and a station (STA) in a MIMO wireless network.

FIG. 1B depicts a schematic diagram of downlink multi-user (MU) communication between an AP and multiple STAs in a MIMO wireless network.

FIG. 1C depicts a schematic diagram of trigger-based uplink MU communication between an AP and multiple STAs in a MIMO wireless network.

FIG. 1D depicts a schematic diagram of trigger-based downlink multi-AP communication between multiple APs and a STA in a MIMO wireless network.

FIG. 1E depicts a format of a PPDU (physical layer protocol data unit (used for downlink multi-user (MU) communications between an AP and multiple STAs in an HE WLAN.

FIG. 1F depicts the HE-SIG-B (HE Signal B) field in more detail.

FIG. 2A depicts an example format of an EHT basic PPDU.

FIG. 2B depicts pre-EHT modulated fields of an EHT basic PPDU with a bandwidth of 320 MHz according to an embodiment.

FIG. 3 depicts an example format of EHT-SIG content channel.

FIG. 4 shows a schematic example of communication apparatus in accordance with various embodiments. The communication apparatus may be implemented as an AP or a STA and configured for RU allocation signalling in accordance with the present disclosure.

FIG. 5 shows a flow diagram illustrating a communication method according to the present disclosure.

FIG. 6 depicts example format of common field of EHT-SIG field of an EHT basic PPDU with a bandwidth of 320 MHz.

FIG. 7 shows a configuration of a communication device, for example an AP according to the present disclosure.

FIG. 8 shows a configuration of a communication device, for example an STA, according to the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for uplink or downlink control signalling, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N × M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

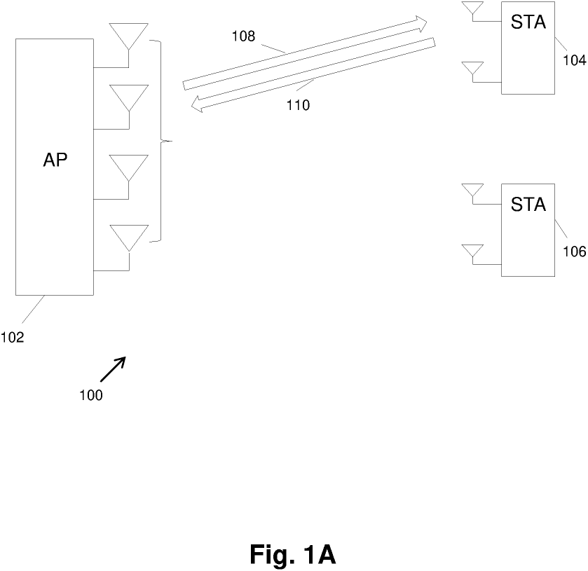

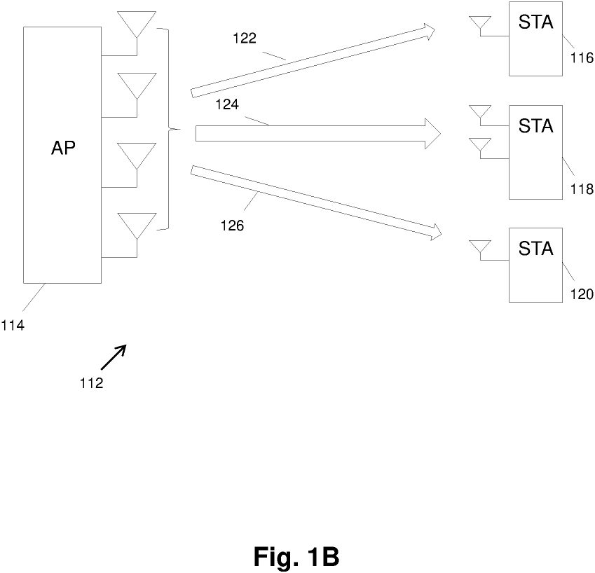

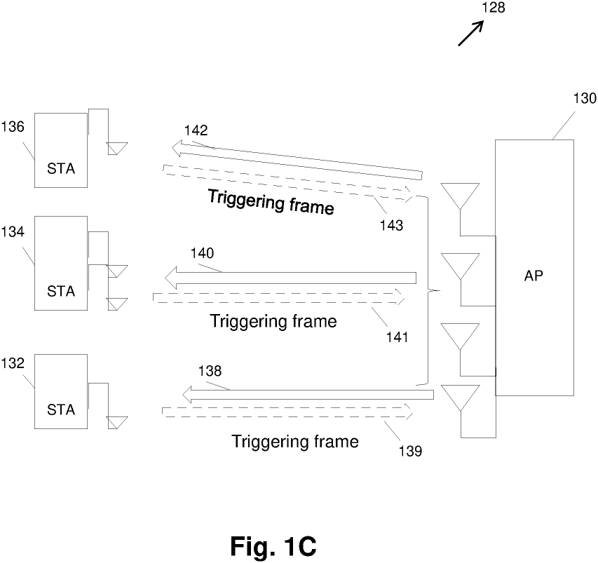

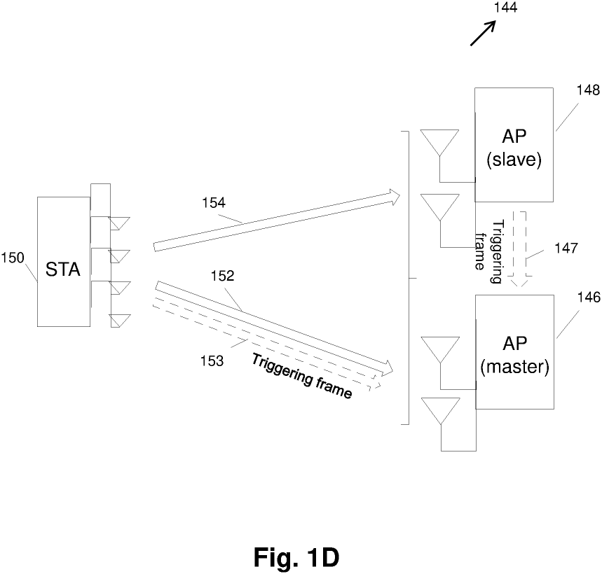

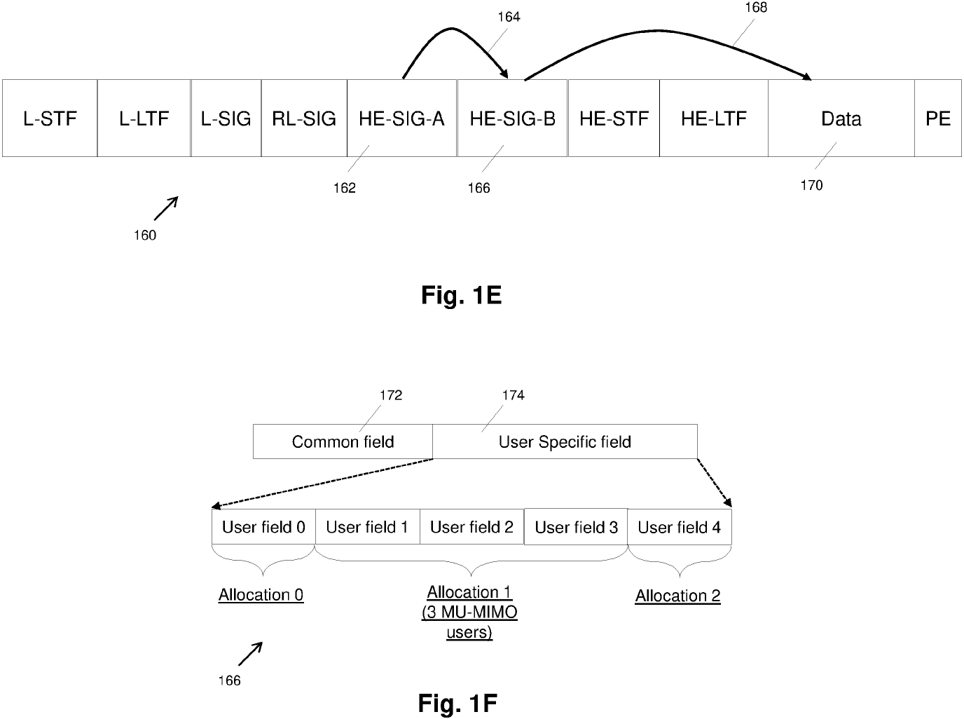

FIG. 1A depicts a schematic diagram of SU communication 100 between an AP 102 and a STA 104 in a MIMO wireless network. As shown, the MIMO wireless network may include one or more STAs (e.g. STA 104, STA 106, etc.). If the SU communication 100 in a channel is carried out over whole channel bandwidth, it is called full bandwidth SU communication. If the SU communication 100 in a channel is carried out over a part of the channel bandwidth (e.g. one or more 20 MHz subchannels within the channel is punctured), it is called punctured SU communication. In the SU communication 100, the AP 102 transmits multiple space-time streams using multiple antennas (e.g. four antennas as shown in FIG. 1A) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1A, in the SU communication 100, the STA 104 may transmit multiple space-time streams using multiple antennas (e.g. two antennas as shown in FIG. 1A) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1A enables both uplink and downlink SU transmissions in a MIMO wireless network.

FIG. 1B depicts a schematic diagram of downlink MU communication 112 between an AP 114 and multiple STAs 116, 118, 120 in a MIMO wireless network. The MIMO wireless network may include one or more STAs (e.g. STA 116, STA 118, STA 120, etc.). The MU communication 112 can be an OFDMA (orthogonal frequency division multiple access) communications or a MU-MIMO communication. For an OFDMA communication in a channel, the AP 114 transmits multiple streams simultaneously to the STAs 116, 118, 120 in the network at different resource units (RUs) within the channel bandwidth. For a MU-MIMO communication in a channel, the AP 114 transmits multiple streams simultaneously to the STAs 116, 118, 120 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g. one or more 20 MHz subchannel within the channel is punctured), the OFDMA or MU-MIMO communication is called punctured OFDMA or MU-MIMO communications. For example, two space-time streams may be directed to the STA 118, another space-time stream may be directed to the STA 116, and yet another space-time stream may be directed to the STA 120. For the sake of simplicity, the two space-time streams directed to the STA 118 are illustrated as a grouped data transmission arrow 124, the space-time stream directed to the STA 116 is illustrated as a data transmission arrow 122, and the space-time stream directed to the STA 120 is illustrated as a data transmission arrow 126.

To enable uplink MU transmissions, trigger-based communication is provided to the MIMO wireless network. In this regard, FIG. 1C depicts a schematic diagram of trigger-based uplink MU communication 128 between an AP 130 and multiple STAs 132, 134, 136 in a MIMO wireless network.

Since there are multiple STAs 132, 134, 136 participating in the trigger-based uplink MU communication, the AP 130 needs to coordinate simultaneous transmissions of multiple STAs 132, 134, 136.

To do so, as shown in FIG. 1C, the AP 130 transmits triggering frames 139, 141, 143 simultaneously to STAs 132, 134, 136 to indicate user-specific resource allocation information (e.g. the number of space-time streams, a starting STS number and the allocated RUs) each STA can use. In response to the triggering frames, STAs 132, 134, 136 may then transmit their respective space-time streams simultaneously to the AP 130 according to the user-specific resource allocation information indicated in the triggering frames 139, 141, 143. For example, two space-time streams may be directed to the AP 130 from STA 134, another space-time stream may be directed to the AP 130 from STA 132, and yet another space-time stream may be directed to the AP 130 from STA 136. For the sake of simplicity, the two space-time streams directed to the AP 130 from STA 134 are illustrated as a grouped data transmission arrow 140, the space-time stream directed to the AP 130 from STA 132 is illustrated as a data transmission arrow 138, and the space-time stream directed to the AP 130 from STA 136 is illustrated as a data transmission arrow 142.

Trigger-based communication is also provided to the MIMO wireless network to enable downlink multi-AP communication. In this regard, FIG. 1D depicts a schematic diagram of downlink multi-AP communication 144, between a STA 150 and multiple APs 146, 148 in a MIMO wireless network.

Since there are multiple APs 146, 148 participating in the trigger-based downlink multi-AP MIMO communication, the master AP 146 needs to coordinate simultaneous transmissions of multiple APs 146, 148.

To do so, as shown in FIG. 1D, the master AP 146 transmits triggering frames 147, 153 simultaneously to the AP 148 and the STA 150 to indicate AP-specific resource allocation information (e.g. the number of space-time streams, a starting STS stream number and the allocated RUs) each AP can use. In response to the triggering frames, the multiple APs 146, 148 may then transmit respective space-time streams to the STA 150 according to the AP-specific resource allocation information indicated in the triggering frame 147; and the STA 150 may then receive all the space-time streams according to the AP-specific resource allocation information indicated in the triggering frame 153. For example, two space-time streams may be directed to the STA 150 from AP 146, and another two space-time streams may be directed to the STA 150 from AP 148. For the sake of simplicity, the two space-time streams directed to the STA 150 from AP 146 are illustrated as a grouped data transmission arrow 152, and the two space-time streams directed to the STA 150 from the AP 148 is illustrated as a grouped data transmission arrow 154.

Due to packet/PPDU (physical layer protocol data unit) based transmission and distributed MAC (medium access control) scheme in 802.11 WLAN, time scheduling (e.g. TDMA (time division multiple access)-like periodic time slot assignment for data transmission) does not exist in 802.11 WLAN. Frequency and spatial resource scheduling is performed on a packet basis. In other words, resource allocation information is on a PPDU basis.

FIG. 1E shows a format of a PPDU 160 used for downlink MU communications between an AP and multiple STAs in a HE WLAN, e.g. OFDMA (Orthogonal Frequency Division Multiple Access) transmission including MU-MIMO transmission in a single RU and full-bandwidth MU-MIMO transmission. Such a PPDU 160 is referred to as an HE MU PPDU 160. The HE MU PPDU 160 may include a non-High Throughput Short Training Field (L-STF), a non-High Throughput Long Training Field (L-LTF), a non-High Throughput SIGNAL (L-SIG) field, a Repeated L-SIG (RL-SIG) field, a HE SIGNAL A (HE-SIG-A) field 162, a HE SIGNAL B (HE-SIG-B) field 166, a HE Short Training Field (HE-STF), a HE Long Training Field (HE-LTF), a Data field 170 and a Packet Extension (PE) field. In the HE MU PPDU 160, the HE-SIG-B field 166 provides the OFDMA and MU-MIMO resource allocation information to allow STAs to look up the corresponding resources to be used in the Data field 160, like indicated by an arrow 168. The HE-SIG-A field 162 contains the necessary information for decoding the HE-SIG-B field 166, e.g. modulation and coding scheme (MCS) for HE-SIG-B, number of HE-SIG-B symbols, like indicated by an arrow 164.

FIG. 1F depicts the HE-SIG-B field 166 in more detail. The HE-SIG-B field 166 includes (or consists of) a Common field 172, if present, followed by a User Specific field 174 which together are referred to as the HE-SIG-B content channel. The HE-SIG-B field 166 contains a RU allocation subfield which indicates the RU information for each of the allocations. The RU information includes a RU position in the frequency domain, an indication of the RU allocated for a non-MU-MIMO or MU-MIMO allocation, and the number of users in the MU-MIMO allocation. The Common field 172 is not present in the case of a full-bandwidth MU-MIMO transmission. In this case, the RU information (e.g. the number of users in the MU-MIMO allocation) is signaled in the HE-SIG-A field 162.

The User Specific field 174 includes (or consists of) one or more user field(s) for non-MU-MIMO allocation(s) and/or MU-MIMO allocation(s). A user field contains user information indicating a user-specific allocation (i.e. user-specific allocation information). In the example shown in FIG. 1F, the User Specific field 174 includes five user fields (User field 0, ..., User field 4), wherein user-specific allocation information for an allocation (Allocation 0) is provided by User field 0, user-specific allocation information for a further allocation (Allocation 1 with 3 MU-MIMO users) is provided by User field 1, User field 2, and User field 3, and user-specific allocation information for yet a further allocation (Allocation 2) is provided by User field 4.

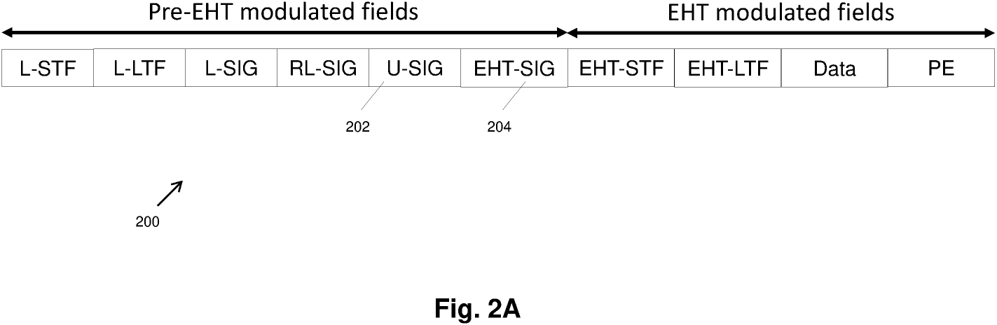

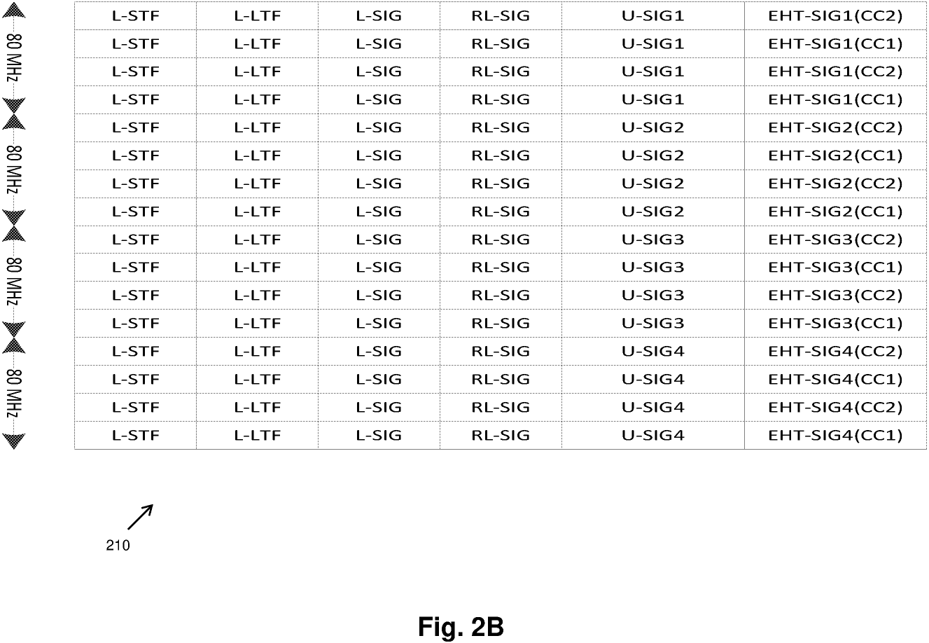

If the MIMO wireless network is with an extremely high throughput, such as an 802.11 be EHT WLAN, the PPDU used for downlink MU transmission, downlink SU transmission or uplink SU transmission may be referred to as EHT basic PPDU 200 like illustrated in FIG. 2A.

According to various embodiments, EHT WLAN supports non-trigger-based communications as illustrated in FIG. 1A and FIG. 1B. In non-trigger-based communications, a communication apparatus transmits a PPDU to one other communication apparatus or more than one other communication apparatuses in an unsolicited manner.

FIG. 2A depicts an example format of an EHT basic PPDU 200, which can be used for non-trigger-based communications. The EHT basic PPDU 200 may include a L-STF, a L-LTF, a L-SIG field, a RL-SIG field 201, a Universal SIGNAL (U-SIG) field 202, an EHT SIGNAL (EHT-SIG) field 204, an EHT-STF, an EHT-LTF, a Data field 210 and a PE field. The L-STF, the L-LTF, the L-SIG field, the RL-SIG field, the U-SIG field and the EHT-SIG field may be grouped as pre-EHT modulated fields, while the EHT-STF, the EHT-LTF, the Data field and the PE field may be grouped as EHT modulated fields. Both U-SIG field 202 and EHT-SIG field 204 are present in the EHT basic PPDU 200 transmitted to a single STA or multiple STAs. It is appreciable that if the IEEE 802.11 Working Group may use a new name instead of “EHT WLAN” for the next generation WLAN with an extremely high throughput, the prefix “EHT” in the above fields may change accordingly. The RL-SIG field 201 is mainly used for identifying any PHY versions starting with 802.11be. The U-SIG field 202 contains the necessary information for decoding the EHT-SIG field 204, e.g. MCS for EHT-SIG, number of EHT-SIG symbols, like indicated by an arrow 204. The U-SIG field 202 and the EHT-SIG field 204 provide necessary information for decoding the Data field 210, like indicated by arrows 207, 208 respectively. When the EHT basic PPDU 200 is transmitted to multiple STAs, the EHT-SIG field 204 provides the OFDMA and MU-MIMO resource allocation information to allow STAs to look up the corresponding resources to be used in the Data field 210.

According to various embodiments, the U-SIG field 202 has a duration of two orthogonal frequency-division multiplexing (OFDM) symbols. Data bits in the U-SIG field 202 are jointly encoded and modulated in the same manner as the HE-SIG-A field of 802.11 ax. Modulated data bits in the U-SIG field 202 are mapped to 52 data tones of each of the two OFDM symbols and duplicated for each 20 MHz within each 80 MHz frequency segment in the same manner as the HE-SIG-A field of 802.11ax. The U-SIG field 202 may carry different information for each of 80 MHz frequency segments. According to various embodiments, the term “frequency segment” may be used interchangeably with the term “subchannel” or “frequency subblock”.

In various embodiments, the U-SIG field 202 may comprise two parts: U-SIG field 1 and U-SIG field 2, each comprising 26 data bits. The U-SIG field 202 comprises all version independent bits and a part of version dependent bits. All version independent bits are included in U-SIG field 1 and have static location and bit definition across different physical layer (PHY) versions, the version independent bits comprising PHY version identifier (3 bits), bandwidth (BW) field (3 bits), uplink/downlink (UL/DL) flag (1 bit), basic service set (BSS) color (e.g. 6 bits) and transmission opportunity (TXOP) duration (e.g. 7 bits). The PHY version identifier of the version independent bits is used to identify the exact PHY version starting with 802.11 be, and the BW field is used to indicate PPDU bandwidth. The effect of including all version-independent bits into one part of the U-SIG field 202, i.e. U-SIG field 1, is that the legacy STAs only require to parse the U-SIG field 1 and thus their power efficiency can be improved. On the other hand, version dependent bits may have variable bit definition in each PHY version. The part of version dependent bits included in the U-SIG field 202 may comprise PPDU format, punctured channel information, pre-FEC (forward error correction) padding factor, PE dis-ambiguity and EHT-SIG related bits which are used for interpreting EHT-SIG field 204, and spatial reuse related bits which are used for coexisting with unintended STAs.

The EHT-SIG field 204 of EHT basic PPDU 200 may include remaining version dependent bits. It has a variable MCS and variable length. EHT-SIG field 504 has a Common field followed by a User Specific field which together are referred to as an EHT-SIG content channel (CC). The User Specific field comprises one or more user field. The Common field may comprise one or more RU allocation subfield indicating RU assignment information for one or more STAs. The EHT-SIG field may vary on each 80 MHz frequency segment.

FIG. 2B depicts the pre-EHT modulated fields of the ETH basic PPDU 200 with a 320 MHz BW according to an embodiment. The 320 MHz PPDU BW comprises four 80 MHz frequency segments and sixteen 20 MHz frequency segments (each 80 MHz frequency segment has four 20 MHz frequency segments). The U-SIG field 202 may carry different information for each of four 80 MHz frequency segments. In other words, U-SIG1 field, U-SIG2 field, U-SIG3 field and U-SIG4 field may be transmitted in the four 80 MHz frequency segments respectively. The EHT-SIG field 204 may vary in each of four 80 MHz frequency segments. In other words, EHT-SIG1 field, EHT-SIG2 field, EHT-SIG3 field and EHT-SIG4 field may be transmitted in the four 80 MHz frequency segments respectively. Further, the EHT-SIG field 204 in each 80 MHz frequency segment comprises two EHT-SIG content channels (CC1 and CC2), each of the two EHT-SIG content channels is duplicated in every other 20 MHz subchannel within the 80 MHz frequency segment, as shown in FIG. 2B.

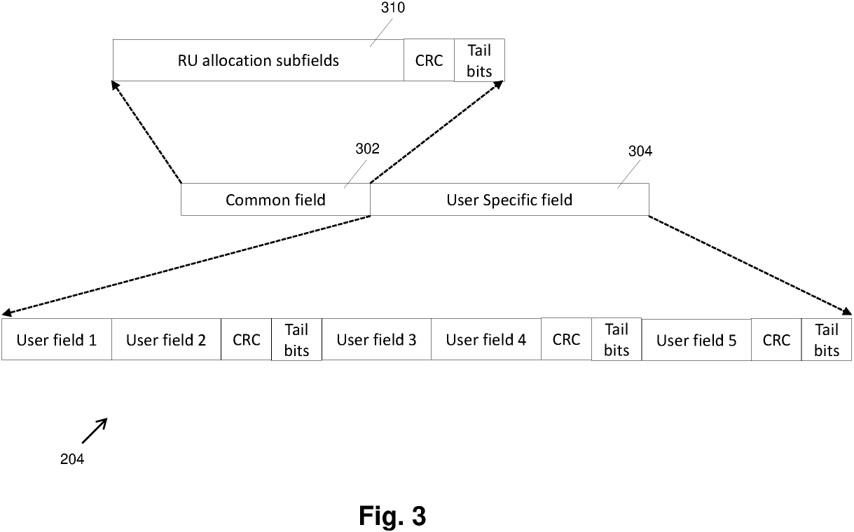

FIG. 3 depicts an example EHT-SIG content channel 300 comprising a Common field 302 and a User Specific field 304. In an embodiment, a User Specific field 304 may consist of one or more User Block field(s), and each User Block field comprises one or two user fields. In this embodiment, the User Block field 1 comprising two user fields like User field 1 and User field 2, User Block field 2 comprising two user fields like User field 3 and User field 4, and User Block field 3 comprising one User field 5, where the one or two user fields in each of User Block fields 1 to 3 is appended with a CRC field for detecting error and tail bits. In an embodiment, the last User Block may consist of one or two user fields depending on the total number of user fields that are allowed in the User Specific field referring to an odd or even number.

According to various embodiments, the User Specific field may comprise a plurality of user fields, such as User fields 1-5, each of which contains transmission parameters corresponding to a STA assigned with a corresponding RU or RU combination. For a RU or RU combination allocated for a non-MU-MIMO transmission, there is a single corresponding user field; and for a RU or RU combination allocated for MU-MIMO transmission with N user, there are N corresponding user fields.

The Common field 302 comprises one or more RU allocation subfield 310 followed by a CRC field and tails bit. The number of RU allocation subfields, N. are dependent on the BW. For example, there are one RU allocation subfield for a 20 MHz or 40 MHz BW PPDU, 2 for an 80 MHz BW PPDU, 4 for 160 MHz or 80+80 MHz BW PPDU, 6 for 240 MHz or 160+80 MHz BW PPDU and 8 for 320 MHz or 160+160 MHz BW PPDU. The RU allocation subfield 310 indicates RU assignment(s), including the size of the RU(s) or RU combinations and their placement in the frequency domain, to be used in the EHT modulated fields of the PPDU; and also indicates information needed to compute the number of users allocated to each RU or RU combination. According to the present disclosure, the subcarrier indices of the RU(s) or RU combination(s) may be within a corresponding 20 MHz subchannel or overlap with a corresponding 20 MHz subchannel if the RU or RU combination is larger than 242-tone RU.

In an embodiment, in an 80 MHz frequency segment where compression mode is enabled, there is no RU allocation subfield(s). Such compression mode in an 80 MHz frequency segment can be enabled if all STA(s) parking in the 80 MHz frequency segment engage in a non-OFDMA transmission. Non-OFDMA transmission refers to MU-MIMO transmission or SU transmission.

In various embodiments of the present disclosure, a STA parks in an 80 MHz frequency segment called listening 80 MHz frequency segment (L80). A STA’s L80 may be primary 80 MHz (P80) by default, or a STA’s L80 may be an 80 MHz frequency segment other than P80 through a negotiation procedure between the STA and AP. RU assignment information for a STA may be completely indicated in EHT-SIG field transmitted in the STA’s L80, the effect of which is the STA only needs to process the pre-EHT modulated fields transmitted in the STA’s L80 to obtain all of its RU assignment information, and power consumption of the STA may be reduced.

As mentioned above, in order to improve spectral efficiency and provide significant peak throughput and capacity increase over 802.11ax HE WLAN, it has been proposed to increase maximum channel bandwidth to 320 MHz and allow multiple contiguous and non-contiguous RUs (i.e. a RU combination) assigned to a single STA. To achieve the above technical advantages, it is an object of present disclosure to provide communication apparatuses and methods for efficient RU allocation signalling to enable assignment of a RU combination to a single STA in an EHT basic PPDU with a bandwidth up to 320 MHz.

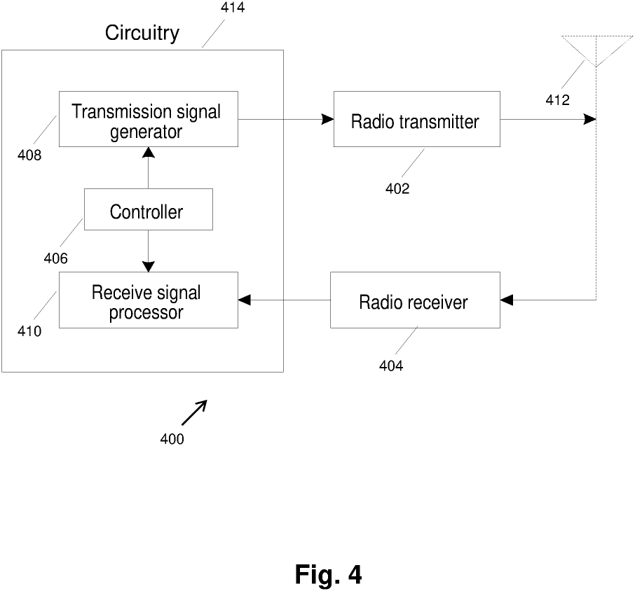

FIG. 4 shows a schematic, partially sectioned view of a communication apparatus 400 according to the present disclosure. The communication apparatus 400 may be implemented as an AP or an STA.

As shown in FIG. 4, the communication apparatus 400 may include circuitry 414, at least one radio transmitter 402, at least one radio receiver 404, and at least one antenna 412 (for the sake of simplicity, only one antenna is depicted in FIG. 4 for illustration purposes). The circuitry 414 may include at least one controller 406 for use in software and hardware aided execution of tasks that the at least one controller 406 is designed to perform, including control of OFDMA or non-OFDMA communications with one or more other communication apparatuses in a MIMO wireless network. The circuitry 414 may furthermore include at least one transmission signal generator 408 and at least one receive signal processor 410. The at least one controller 406 may control the at least one transmission signal generator 408 for generating PPDUs (for example PPDUs used for non-trigger-based communications) to be sent through the at least one radio transmitter 402 to one or more other communication apparatuses and the at least one receive signal processor 410 for processing PPDUs (for example PPDUs used for non-trigger-based communications received through the at least one radio receiver 404 from the one or more other communication apparatuses under the control of the at least one controller 406. The at least one transmission signal generator 408 and the at least one receive signal processor 410 may be stand-alone modules of the communication apparatus 400 that communicate with the at least one controller 406 for the above-mentioned functions, as shown in FIG. 4. Alternatively, the at least one transmission signal generator 408 and the at least one receive signal processor 410 may be included in the at least one controller 406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 402, at least one radio receiver 404, and at least one antenna 412 may be controlled by the at least one controller 406.

The communication apparatus 400, when in operation, provides functions required for RU allocation signalling. For example, the communication apparatus 600 may be an AP, and the circuitry 414 (for example the at least one transmission signal generator 408 of the circuitry 414) may, in operation, generates a PPDU comprising two signal field content channels in each 80 MHz frequency segment, each of the two signal field content channels comprising a plurality of RU allocation subfields, wherein a value of each of the plurality of RU allocation subfields is able to indicate sizes of component RUs of a large-size RU combination. The radio transmitter 402 may in operation, transmits the PPDU.

The communication apparatus 400 may be a STA, and the radio receiver 604 may, in operation, receives a PPDU comprising two signal field content channels in each 80 MHz frequency segment, each of the two signal field content channels comprising a plurality of RU allocation subfields, wherein a value of each of the plurality of RU allocation subfields is able to indicate sizes of component RUs of a large-size RU combination. The circuitry 414 (for example the at least one receive signal processor 410 of the circuitry 414) may, in operation, processes the PPDU.

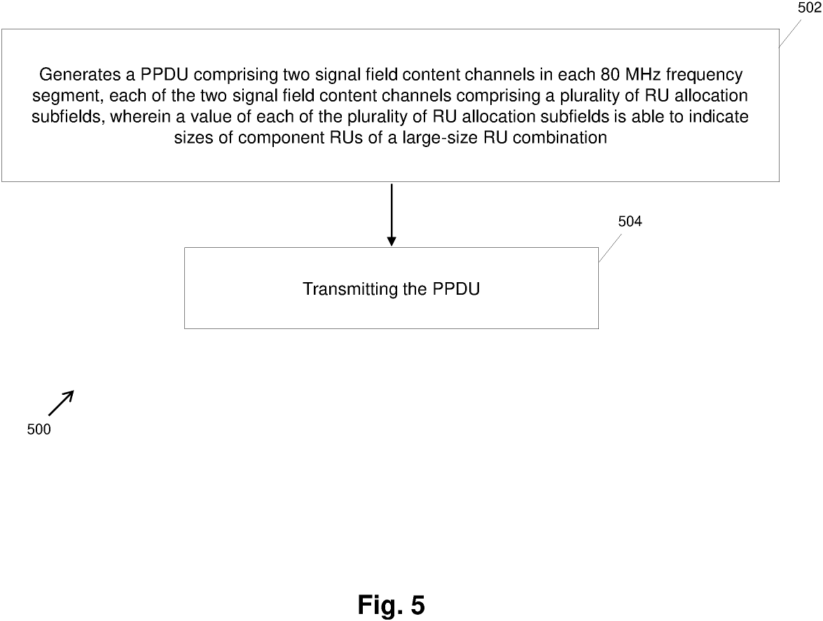

FIG. 5 shows a flow diagram 500 illustrating a communication method for transmitting a PPDU according to the present disclosure. In step 502, a PPDU is generated, the PPDU comprising two signal field content channels in each 80 MHz frequency segment, each of the two signal field content channels comprising a plurality of RU allocation subfields, wherein a value of each of the plurality of RU allocation subfields is able to indicate sizes of component RUs of a large-size RU combination. In step 504, the generated PPDU is transmitted to a plurality of other communication apparatuses.

According to the present disclosure, a value of each RU allocation subfield of a plurality of RU allocation subfields in a PPDU is able to indicate sizes of component RUs of a large-size RU combination.

According to the present disclosure, a value of each RU allocation subfield of a plurality of RU allocation subfields in a PPDU may not able to indicate any information on frequency-domain positions of component RUs of a large-size RU combination. In particular, for each PPDU BW equal to or larger than 80 MHz, frequency-domain positions of component RUs of a large-size RU combination depend on one of: (i) a RU allocation subfield index, and (ii) the RU allocation subfield index and an EHT-SIG content channel (CC) index. An index of a RU allocation subfield in an EHT-SIG CC represents ordering or position of the RU allocation subfield among a plurality of RU allocation subfields in the same EHT-SIG content channel. As such, for each PPDU BW equal to or larger than 80 MHz, mapping between frequency-domain positions of component RUs for each of large-size RU combinations and EHT-SIG CC indices and RU allocation subfield indices need to be defined. Advantageously, the number of entries required for large-size RU combinations in RU allocation table is minimized.

Mapping between frequency-domain positions of component RUs of each of large-size RU combinations and EHT-SIG CC indices and/or RU allocation subfield indices should be defined in such a manner that frequency-domain positions of component RUs of each of large-size RU combinations can be determined according to RU allocation subfield index and/or EHT-SIG CC index using one or more formula which will be discussed further in the following. Advantageously, memory for storing such a mapping may not be required.

According to various embodiments, a MU-MIMO allocation for a RU or RU combination in an EHT basic PPDU has a maximum number of spatial streams of 16, a maximum number of users of 8 (i.e. Nᵤₛₑᵣ ≤ 8), a maximum number of spatial streams per user of 4 and a minimum RU size to support MU-MIMO is 242-tone RU. More than one RUs are allowed to be allocated to a single STA in an EHT basic PPDU. In various embodiments, where RUs with sizes equal to or more than 242 tones are defined as large-size RUs and RUs with size less than 242 tones are defined as small-size RUs, allowed small-size RU combinations for OFDMA transmission may include (i) one 26-tone RU (RU26) and one 52-tone RU (RU52); and (ii) one RU26 and one 106-tone RU (RU106); whereas allowed large-size RU combinations for OFDMA transmission may include (i) one 242-tone RU (RU242) and one 484-tone RU (RU484), (ii) one RU484 and one 996-tone RU (RU996), (iii) two RU996, (iv) two RU996 and one RU484, (v) three RU996 and (vi) three RU996 and one RU484. It should be noted that a small-size or large-size RU combination comprises two or more component RUs. For example, a RU combination of one RU242 and one RU484 comprises two component RUs: RU242 and RU484. Tables 1 to 3 show values of the RU allocation subfield 308 signaling assignments of small-size RUs, small-size RU combinations, large-size RUs, and large-size RU combinations respectively according to an embodiment. It should be noted that a large-size RU combination has the same RU allocation subfield values (e.g. 144-151 for a combination of one RU242 and one RU484) regardless of frequency-domain positions of component RUs of the large-size RU combination. In other words, according to Tables 1 to 3, a RU allocation subfield value is able to indicate sizes of component RUs of a large-size RU combination: but is not able to indicate any information on frequency-domain positions of component RUs of a large-size RU combination.

In the embodiment, according to Tables 1 to 3, #1 to #9 (from left to right of the tables) is ordered in increasing order of the absolute frequency. Among RU allocation subfield values of 32-54, “26+52” or “52+26” refers to an allowed small-size RU combination of two adjacent RU26 and RU52. “106+26” or “26+106” refers to an allowed small-size RU combination of two adjacent RU26 and RU106. For signaling RUs or RU combination of size is greater than 242 tones, letter y₂y₁y₀, or the last three digits of the binary vector, of the RU Allocation subfield value may indicate the number of user fields in the EHT-SIG content channel that contains the corresponding RU Allocation subfield. Otherwise, the binary vector y₂y₁y₀, indicates the number of users multiplexed in the RU242. In an embodiment, the number of user, Nᵤₛₑᵣ(r), multiplexed in the RU r or RU combination r can be calculated based on the following equation:

$${N}_{\text{user}} \left(r\right) = 4 \times {y}_{2} + 2 \times {y}_{1} + {y}_{0} + 1$$

In other words, for a large-size RU r or a large-size RU combination r, if the letter y₂y₁y₀, are present in the RU allocation subfield, the Nᵤₛₑᵣ(r) is indicated by the letter; if the letter y₂y₁y₀, is not present, Nᵤₛₑᵣ(r) is 0. For a small-size RU r or a small-size RU combination r, the number of user field Nᵤₛₑᵣ(r) is 1. In an embodiment, “-” in the Tables 1-3 means no user is assigned with that RU, i.e. Nᵤₛₑᵣ(r) = 0.

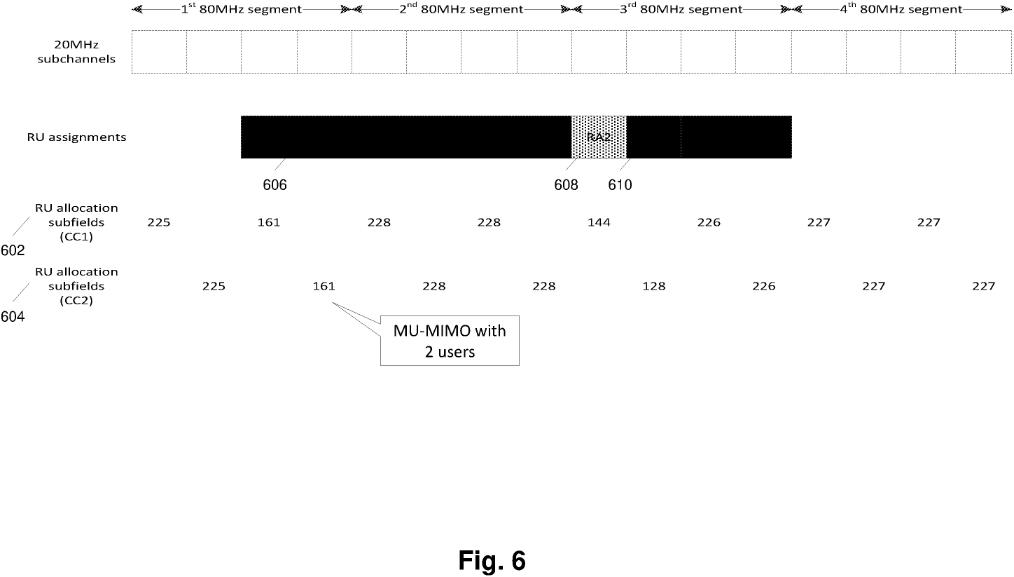

FIG. 6 depicts example Common fields of EHT-SIG CC1 602 and CC2 604 transmitted in an 80 MHz frequency segment used for signalling large-size RU assignments and large-size RU combination assignments in a 320 MHz (or 160+160 MHz) BW EHT basic PPDU. In this example, three RUs or RU combinations are assigned, in particular: (i) a large-size RU combination allocation (RA1) 606 in 1^{st} and 2^{nd} 80 MHz frequency segments for a MU-MIMO transmission with four users, (ii) a large-size RU combination allocation (RA2) 608 in 3^{rd} 80 MHz frequency segment for a non-MU-MIMO transmission, and (iii) a large-size RU allocation (RA3) 610 in 2^{nd} 20 MHz subchannel of 3^{rd} 80 MHz frequency segment for a non-MU-MIMO transmission.

The EHT-SIG CC1 602 comprises eight RU allocation subfields with values of 225, 161, 228, 228, 144, 226, 227 and 227 which correspond to the 1^{st}, 3^{rd}, 5^{th.} 7^{th,} 9^{th}, 11^{th.} 13^{th} and 15^{th} 20 MHz frequency segments respectively: whereas the EHT-SIG CC2 604 comprises eight RU allocation subfields with values of 225, 161, 228, 228, 128, 226, 227 and 227 which correspond to the 2^{nd}, 4^{th}, 6^{th}, 8^{th}, 10^{th}, 12^{th}, 14^{th} and 16^{th} 20 MHz frequency segments. In accordance with tables 1-3, a RU allocation subfield value of 225 indicates a RU484 contributing zero User field to the User Specific field in the same EHT-SIG CC as this RU allocation subfield; a value of 161 indicates a RU combination of one RU484 and one RU996 contributing two user fields to the User Specific field in the same EHT-SIG content channel as this RU allocation subfield; a value of 228 indicates a RU combination of one RU484 and one RU996 contributing zero user field to the User Specific field in the same EHT-SIG CC as this RU allocation subfield; a value of 144 indicates a RU combination of one RU242 and one RU484 contributing one user field to the User Specific field in the same EHT-SIG CC as this RU allocation subfield; a value of 226 indicates a RU combination of one RU242 and one RU484 contributing zero user field to the User Specific field in the same EHT-SIG CC as this RU allocation subfield; a value of 227 indicates a single RU assignment of RU996 contributing zero user field to the User Specific field in the same EHT-SIG CC as this RU allocation subfield; and a value of 128 indicates a single RU assignment of RU242 contributing one user field to the User Specific field. Each of EHT-SIG CC1 602 and EHT-SIG CC2 604 has three user fields in its User Specific field for load balancing purpose.

It is noted that the user fields corresponding to the MU-MIMO allocation RA1 506 are split between two EHT-SIG CCs. In this case, the total number of users and the total number of spatial streams in the RA1 506 are the sum of the number of users and number of spatial streams per user, respectively, indicated in both EHT-SIG CCs.

As illustrated above and in FIG. 2B, an EHT-SIG field in each 80 MHz frequency segment (with four 20 MHz subchannels) comprises two EHT-SIG CCs (CC1 and CC2), each of the two EHT-SIG CCs is duplicated in every other 20 MHz subchannel within the 80 MHz frequency segment.

Mappings of frequency-domain positions of large-size RUs or RU combinations in (i) an 80 MHz, (ii) a 160 MHz or 80+80 MHz, (iii) a 240 MHz or 160+80 MHz and (iv) a 320 or 160+160 MHz BW PPDU according to an embodiment are depicted in Table 4-7 respectively.

Table 4 depicts mapping of frequency-domain positions of large-size RUs or RU combinations in an 80 MHz BW PPDU according to an embodiment. In this embodiment where the 80 MHz BW PPDU is allocated with a large-size RU combination of one 484-tone RU and one 242-tone RU, the frequency-domain positions of the components RUs of the large-size RU combination, depend on the RU allocation (RUA) subfield index and the EHT-SIG CC index.

When a RUA subfield m (m = 1 or 2) in an EHT-SIG CC n (n = 1 or 2) indicates a 242-tone RU (RUA subfield value in a range of 128-135) is allocated for an 80 MHz BW PPDU, the index i of the 242-tone RU indicated by the RUA subfield m in the EHT-SIG CC n can be determined based on the EHT-SIG CC index n and the RUA subfield index m using the following equation (2):

$$i = 2 \times \left(m - 1\right) + n$$

where n is 1 to 2 referring to EHT-SIG CC1 and CC2 respectively, and m is 1 to 2 referring to RUA1 and RUA2 of each EHT-SIG CC in the 80 MHz BW PPDU respectively. The 242-tone RU index i, ranged between 1 to 4, can be used to represent the respective frequency-domain positions of the 242-tone RUs, i.e. 242-tone RU1 to RU4, within the 80 MHz PPDU BW.

When a RUA subfield m (m = 1 or 2) in an EHT-SIG CC n (n= 1 or 2) indicates a 484-tone RU (RUA subfield value in a range of 136-143) is allocated for an 80 MHz BW PPDU, the index j of the 484-tone RU indicated by the RUA subfield m in the EHT-SIG CC n can be determined based on the RUA subfield index m using the following equation (3):

$$j = m$$

where m is 1 to 2 referring to RUA1 and RUA2 of each EHT-SIG CC in the 80 MHz BW PPDU respectively. The 484-tone RU index j, ranged between 1 to 2, can be used to represent the respective frequency-domain positions of the 484-tone RUs, i.e. 484-tone RU1 and RU2, within the 80 MHz PPDU BW.

When a RUA subfield m (m = 1 or 2) in an EHT-SIG CC n (n = 1 or 2) indicates a RU combination of one 484-tone RU and one 242-tone RU (RUA subfield value in a range of 144-151) is allocated for an 80 MHz BW PPDU, the index i of component 242-tone RU of the RU combination indicated by the RUA subfield m in the EHT-SIG CC n can be determined based on the EHT-SIG CC index n and the RUA subfield index m using the following equation (4); while the index j of component 484-tone RU of the RU combination indicated by the RUA subfield m in the EHT-SIG CC n can be determined based on the RUA subfield index m using the following equation (5):

$$i = 2 \times \left(2 - m\right) + n$$

$$j = m$$

where n is 1 to 2 referring to EHT-SIG CC1 and CC2 respectively, and m is 1 to 2 referring to RUA1 and RUA2 of each EHT-SIG CC in the 80 MHz BW PPDU respectively. The 242-tone RU index i, ranged between 1 to 4, and the 484-tone RU index j, ranged between 1 to 2, can be used to represent the respective frequency-domain positions of the 242-tone RUs (i.e. 242-tone RU1 to RU4) and the 484-tone RUs (i.e. 484-tone RU1 and RU2), within the 80 MHz PPDU BW.

Table 5 depicts mapping of frequency-domain positions of large-size RUs or RU combinations in a 160 MHz or 80+80 MHz BW PPDU according to an embodiment. In this embodiment where the 160 MHz or 80+80 MHz BW PPDU is allocated with a large-size RU combination of one 484-tone RU and one 242-tone RU, the frequency-domain positions of the component RUs of the large-size RU combination depend on the RUA subfield index and the EHT-SIG CC index; and where the 160 MHz or 80+80 MHz BW PPDU is allocated with a large-size RU combination of one 996-tone RU and one 484-tone RU, the frequency-domain positions of the component RUs of the large-size RU combinations depend on the RUA subfield index. It may be defined that the 160 MHz or 80+80 MHz BW PPDU is allocated with a large size RU combination of one 484-tone RU and one 242 RU within the same 80 MHz as depicted in Table 5. It should be noted that the combination of one 484-tone RU in an 80 MHz segment (e.g. 484-tone RU1) and one 242-tone RU in another 80 MHz segment (e.g. 242-tone RU5) is not allowed so that the EHT-SIG CC index can indicate which 242-tone RU is combined with the 484-tone RU.

When a RUA subfield m (m = 1, 2, 3 or 4) in an EHT-SIG CC n (n = 1 or 2) indicates a 242-tone RU (RUA subfield value in a range of 128-135) is allocated for an 160 MHz or 80+80 MHz BW PPDU, the index i of the 242-tone RU indicated by the RUA subfield m in the EHT-SIG CC n can be determined based on EHT-SIG CC index n and the RUA subfield index m using the following equation (6):

$$i = 2 \times \left(m - 1\right) + n$$

where n is 1 to 2 referring to EHT-SIG CC1 and CC2 respectively, and m is 1 to 4 referring to RUA1 to RUA4 of each EHT-SIG CC in the 160 MHz or 80+80 MHz BW PPDU respectively. The 242-tone RU index i, ranged between 1 to 8, can be used to represent the respective frequency-domain positions of the 242-tone RUs, i.e. 242-tone RU1 to RU8, within the 160 MHz or 80+80 MHz PPDU BW.

When a RUA subfield m (m =1, 2, 3 or 4) in an EHT-SIG CC n (n =1 or 2) indicates a 484-tone RU (RUA subfield value in a range of 136-143) is allocated for an 160 MHz or 80+80 MHz BW PPDU, the index j of the 484-tone RU indicated by the RUA subfield m in the EHT-SIG CC n can be determined based on the RUA subfield index m using the following equation (7):

$$j = m$$

where m is 1 to 4 referring to RUA1 to RUA4 of each EHT-SIG CC in the 160 MHz or 80+80 MHz BW PPDU respectively. The 484-tone RU index j, ranged between 1 to 4, can be used to represent the respective frequency-domain positions of the 484-tone RUs, i.e. 484-tone RU1 to RU4, within the 160 MHz or 80+80 MHz PPDU BW.

When a RUA subfield m (m =1, 2, 3 or 4) in an EHT-SIG CC n (n =1 or 2) indicates a RU combination of one 484-tone RU and one 242-tone RU (RUA subfield value in a range of 144-151) is allocated for a 160 MHz or 80+80 MHz BW PPDU, the index i of the component 242-tone RU of the RU combination indicated by the RUA subfield m in the EHT-SIG CC n can be determined based on the EHT-SIG CC index n and the RUA subfield index m using the following equation (8); while the index j of the component 484-tone RU of the RU combination indicated by the RUA subfield m in the EHT-SIG CC n can be determined based on the RUA subfield index m using the following equation (9):

$$i = 8 \times c e i l \left(\frac{m}{2}\right) - 2 m + n - 4$$

$$j = m$$

where n is 1 to 2 referring to EHT-SIG CC1 and CC2 respectively, m is 1 to 4 referring to RUA1 to RUA4 of each EHT-SIG CC in the 160 MHz or 80+80 MHz BW PPDU respectively, and the ceil(x) function always rounds a number x up to the next largest integer. The 242-tone RU index i, ranged between 1 to 8, can be used to represent the respective frequency-domain positions of the 242-tone RUs, i.e. 242-tone RU1 to RU8, within the 160 MHz or 80+80 MHz PPDU BW. The 484-tone RU index j, ranged between 1 to 4, can be used to represent the respective frequency-domain positions of the 484-tone RUs, i.e. 484-tone RU1 to RU4, within the 160 MHz or 80+80 MHz PPDU BW.

When a RUA subfield m (m =1, 2, 3 or 4) in an EHT-SIG CC n (n =1 or 2) indicates a 996-tone RU (RUA subfield value in a range of 152-159) is allocated for an 160 MHz or 80+80 MHz BW PPDU, the index k of the 996-tone RU indicated by the RUA subfield m in the EHT-SIG CC n can be determined based on the RUA subfield index m using the following equation (10):

$$k = c e i l \left(\frac{m}{2}\right)$$

where m is 1 to 4 referring to RUA1 to RUA4 of each EHT-SIG CC in the 160 MHz or 80+80 MHz BW PPDU respectively. The 996-tone RU index k, ranged between 1 to 2, can be used to represent the respective frequency-domain positions of the 996-tone RUs, i.e. 996-tone RU1 and RU2, within the 160 MHz or 80+80 MHz PPDU BW.

When a RUA subfield m (m =1, 2, 3 or 4) in an EHT-SIG CC n (n =1 or 2) indicates a RU combination of one 996-tone RU and one 484-tone RU (RUA subfield value in a range of 176-183) is allocated for a 160 MHz or 80+80 MHz BW PPDU, the index j of the component 484-tone RU and the index k of the component 996-tone RU of the RU combination indicated by the RUA subfield m in the EHT-SIG CC n can be determined based on the RUA subfield index m using the following equations (11) and (12) respectively:

$$j = m - 4 \times c e i l \left(\frac{m}{2}\right) + 6$$

$$k = c e i l \left(\frac{m}{2}\right)$$

where m is 1 to 4 referring to RUA1 to RUA4 of each EHT-SIG CC in the 160 MHz or 80+80 MHz BW PPDU respectively. The 484-tone RU index j, ranged between 1 to 4, can be used to represent the respective frequency-domain positions of the 484-tone RUs, i.e. 484-tone RU1 to RU4, within the 160 MHz or 80+80 MHz PPDU BW. The 996-tone RU index k, ranged between 1 to 2, can be used to represent the respective frequency-domain positions of the 996-tone RUs, i.e. 996-tone RU1 and RU2, within the 160 MHz or 80+80 MHz PPDU BW.

Table 6 depicts mapping of frequency-domain positions of large-size RUs or RU combinations in a 240 MHz or 160+80 MHz BW PPDU according to an embodiment. In this embodiment where the 240 MHz or 160+80 MHz BW PPDU is allocated with a large-size RU combination of one 484-tone RU and one 242-tone RU, the frequency-domain positions of the components RUs of the large-size RU combination depend on the RUA subfield index and the EHT-SIG CC index; where the 240 MHz or 160+80 MHz BW PPDU is allocated with a large-size RU combination of one 996-tone RU and one 484-tone RU, the frequency-domain positions of the component RUs of the large-size RU combination depend on the RUA subfield index and the EHT-SIG CC index; where the 240 MHz or 160+80 MHz BW PPDU is allocated with a large-size RU combination of two 996-tone RUs, the frequency-domain positions of the components RUs of the large-size RU combination depend on the RUA subfield index; where the 240 MHz or 160+80 MHz BW PPDU is allocated with a large-size RU combination of two 996-tone RUs and one 484-tone RU, the frequency-domain positions of the components RUs of the large-size RU combination depends on the RUA subfield index and the EHT-SIG CC index.

When a RUA subfield m (m =1 to 6) in an EHT-SIG CC n (n =1 or 2) indicates a 242-tone RU (RUA subfield value in a range of 128-135) is allocated for an 240 MHz or 160+80 MHz BW PPDU, the index i of the 242-tone RU indicated by the RUA subfield m in the EHT-SIG CC n can be determined based on the EHT-SIG CC index n and the RUA subfield index m using the following equation (13):

$$i = 2 \times \left(m - 1\right) + n$$

where n is 1 to 2 referring to EHT-SIG CC1 and CC2 respectively, and m is 1 to 6 referring to RUA1 to RUA6 of each EHT-SIG CC in the 240 MHz or 160+80 MHz BW PPDU respectively. The 242-tone RU index i, ranged between 1 to 12, can be used to represent the respective frequency-domain positions of the 242-tone RUs, i.e. 242-tone RU1 to RU12, within the 240 MHz or 160+80 MHz PPDU BW.

When a RUA subfield m (m =1 to 6) in an EHT-SIG CC n (n =1 or 2) indicates a 484-tone RU (RUA subfield value in a range of 136-143) is allocated for an 240 MHz or 160+80 MHz BW PPDU, the index j of the 484-tone RU indicated by the RUA subfield m in the EHT-SIG CC n can be determined based on the RUA subfield index m using the following equation (14):

$$j = m$$

where m is 1 to 6 referring to RUA1 to RUA6 of each EHT-SIG CC in the 240 MHz or 160+80 MHz BW PPDU respectively. The 484-tone RU index j, ranged between 1 to 6, can be used to represent the respective frequency-domain positions of the 484-tone RUs, i.e. 484-tone RU1 to RU6, within the 240 MHz or 160+80 MHz PPDU BW.

When a RUA subfield m (m =1 to 6) in an EHT-SIG CC n (n =1 or 2) indicates a RU combination of one 484-tone RU and one 242-tone RU (RUA subfield value in a range of 144-151) is allocated for a 240 MHz or 160+80 MHz BW PPDU, the index i of the component 242-tone RU of the RU combination indicated by the RUA subfield m in the EHT-SIG CC n can be determined based on the EHT-SIG CC index n and the RUA subfield index m using the following equation (15); while the index j of the component 484-tone RU of the RU combination indicated by the RUA subfield m in the EHT-SIG CC n can be determined based on the RUA subfield index m using the following equation (16):

$$i = 8 \times c e i l \left(\frac{m}{2}\right) - 2 m + n - 4$$

$$j = m$$

where n is 1 to 2 referring to EHT-SIG CC1 and CC2 respectively, and m is 1 to 6 referring to RUA1 to RUA6 of each CC in the 240 MHz or 160+80 MHz BW PPDU respectively. The 242-tone RU index i, ranged between 1 to 12, can be used to represent the respective frequency-domain positions of the 242-tone RUs, i.e. 242-tone RU1 to RU12, within the 240 MHz or 160+80 MHz PPDU BW. The 484-tone RU index j, ranged between 1 to 6, can be used to represent the respective frequency-domain positions of the 484-tone RUs, i.e. 484-tone RU1 to RU6, within the 240 MHz or 160+80 MHz PPDU BW.

When a RUA subfield m (m =1 to 6) in an EHT-SIG CC n (n =1 or 2) indicates a 996-tone RU (RUA subfield value in a range of 152-159) is allocated for an 240 MHz or 160+80 MHz BW PPDU, the index k of the 996-tone RU indicated by the RUA subfield m in the EHT-SIG CC n can be determined based on the RUA subfield index m using the following equation (17):

$$k = c e i l \left(\frac{m}{2}\right)$$

where m is 1 to 6 referring to RUA1 to RUA6 of each EHT-SIG CC in the 240 MHz or 160+80 MHz BW PPDU respectively. The 996-tone RU index k, ranged between 1 to 3, can be used to represent the respective frequency-domain positions of the 996-tone RUs, i.e. 996-tone RU1 to RU3, within the 240 MHz or 160+80 MHz PPDU BW.

When a RUA subfield m (m =1 to 6) in an EHT-SIG CC n (n =1 or 2) indicates a RU combination of one 996-tone RU and one 484-tone RU (RUA subfield value in a range of 160-167) is allocated for a 240 MHz or 160+80 MHz BW PPDU, the index j of the component 484-tone RU of the RU combination indicated by the RUA subfield m in the EHT-SIG CC n can be determined based on the RUA subfield index m and the EHT-SIG CC index n using the following equations (18) and (19); while the index k of the component 996-tone RU of the RU combination indicated by the RUA subfield m in the EHT-SIG CC n can be determined based on the RUA subfield index m using the following equation (20):

$$j = m - 4 \times c e i l \left(\frac{m}{2}\right) + 6$$

$$j = \left(m - 3\right) \times 4 + n$$

$$k = c e i l \left(\frac{m}{2}\right)$$

where m is 1 to 6 referring to RUA1 to RUA6 of each EHT-SIG CC in the 240 MHz or 160+80 MHz BW PPDU respectively; and n is 1 and 2 referring to EHT-SIG CC1 and CC2 respectively. The 484-tone RU index j, ranged between 1 to 6, can be used to represent the respective frequency-domain positions of the 484-tone RUs, i.e. 484-tone RU1 to RU6, within the 240 MHz or 160+80 MHz PPDU BW. The 996-tone RU index k, ranged between 1 to 3, can be used to represent the respective frequency-domain positions of the 996-tone RUs, i.e. 996-tone RU1 to RU3, within the 240 MHz or 160+80 MHz PPDU BW.

When a RUA subfield m (m =1 to 6) in an EHT-SIG CC n (n =1 or 2) indicates a RU combination of two 996-tone RUs (RUA subfield value in a range of 168-175) is allocated for a 240 MHz or 160+80 MHz BW PPDU, the index k₁ of the first component 996-tone RU and the index k₂ of the second component 996-tone RU of the RU combination indicated by the RUA subfield m in the EHT-SIG CC n can be determined based on the RUA subfield index m using the following equations (21) and (22) respectively:

$${k}_{1} = c e i l \left(\frac{m}{3}\right)$$

$${k}_{2} = m o d \left({k}_{1} , 3\right) + 1$$

where m is 1 to 6 referring to RUA1 to RUA6 of each EHT-SIG CC in the 240 MHz or 160+80 MHz BW PPDU respectively; and the function mod(x, y) returns the remainder after division of x by y. The 996-tone RU index k₁ or k₂, ranged between 1 to 3, can be used to represent the respective frequency-domain positions of the 996-tone RUs, i.e. 996-tone RU1 to RU3, within the 240 MHz or 160+80 MHz PPDU BW PPDU.

When a RUA subfield m (m =1 to 6) in an EHT-SIG CC n (n =1 or 2) indicates a RU combination of two 996-tone RUs and one 484-tone RU (RUA subfield value in a range of 176-183) is allocated for a 240 MHz or 160+80 MHz BW PPDU, the index j of the component 484-tone RU of the RU combination indicated by the RUA subfield m in the EHT-SIG CC n can be determined based on the RUA subfield index m and the EHT-SIG CC index n using the following equation (23), while the index k₁ of the first component 996-tone RU and the index k₂ of the second component 996-tone RU of the RU combination indicated by the RUA subfield m in the EHT-SIG CC n can be determined based on the RUA subfield index m using the following equations (24) and (25) respectively:

$$j = n - 4 \times c e i l \left(\frac{m}{3}\right) + 8$$

$${k}_{1} = c e i l \left(\frac{m}{3}\right)$$

$${k}_{2} = m o d \left({k}_{1} , 3\right) + 1$$

where n is 1 to 2 referring to EHT-SIG CC1 and CC2 respectively, and m is 1 to 6 referring to RUA1 to RUA6 of each EHT-SIG CC in the 240 MHz or 160+80 MHz BW PPDU respectively. The 484-tone RU index j, ranged between 1 to 6, can be used to represent the respective frequency-domain positions of the 484-tone RU\s, i.e. 484-tone RU1 to RU6, within the 240 MHz or 160+80 MHz PPDU BW PPDU. The 996-tone RU index k₁ or k₂, ranged between 1 to 3, can be used to represent the respective frequency-domain positions of the 996-tone RUs, i.e. 996-tone RU1 to RU3, within the 240 MHz or 160+80 MHz PPDU BW PPDU.

Table 7 depicts mapping of frequency positions of large-size RUs or RU combinations in a 360 MHz or 160+160 MHz BW PPDU according to an embodiment. In this embodiment where the 360 MHz or 160+160 MHz BW PPDU is allocated with a large-size RU combination of one 484-tone RU and one 242-tone RU, the frequency-domain positions of the components RUs of the large-size RU combination depend on the RUA subfield index and the EHT-SIG CC index; where the 360 MHz or 160+160 MHz BW PPDU is allocated with a large-size RU combination of one 996-tone RU and one 484-tone RU, the frequency-domain positions of the component RUs of the large-size RU combination depend on the RUA subfield index; where the 360 MHz or 160+160 MHz BW PPDU is allocated with a large-size RU combination of two 996-tone RUs, the frequency-domain positions of the components RUs of the large-size combination depend on the RUA subfield index; where the 360 MHz or 160+160 MHz BW PPDU is allocated with a large-size RU combination of two 996-tone RUs and one 484-tone RU, the frequency-domain positions of the components RUs of the large-size RU combination depend on the RUA subfield index; and where the 360 MHz or 160+160 MHz BW PPDU is allocated with a large-size RU combination of three 996-tone RUs or a large-size RU combination of three 996-tone RUs and one 484-tone RU, the frequency-domain positions of the components RUs of the large-size RU combinations depend on the RU allocation subfield index. It may be defined that the 360 MHz or 160+160 MHz BW PPDU is allocated with a large size RU combination of one 484-tone RU and one 242 RU within the same 80 MHz as depicted in Table 7. It may also be defined that the 360 MHz or 160+160 MHz BW PPDU is allocated with a large size RU combination of one 996-tone RU and one 484 RU within the same 80 MHz as depicted in Table 7. It should be noted that the combination of one 996-tone RU in an 160 MHz segment (e.g. 996-tone RU1) and one 484-tone RU in another 160 MHz segment (e.g. 484-tone RU5) is not allowed so that the position of the RUA subfield can indicate which 484-tone RU is combined with the 996-tone RU.

When a RUA subfield m (m =1 to 8) in an EHT-SIG CC n (n =1 or 2) indicates a 242-tone RU (RUA subfield value in a range of 128-135) is allocated for a 360 MHz or 160+160 MHz BW PPDU, the index i of the 242-tone RU indicated by the RUA subfield m in the EHT-SIG CC n can be determined based on the EHT-SIG CC index n and the RUA subfield index m using the following equation (26):

$$i = 2 \times \left(m - 1\right) + n$$

where n is 1 to 2 referring to EHT-SIG CC1 and CC2 respectively, and m is 1 to 8 referring to RUA1 to RUA8 of each EHT-SIG CC in the 360 MHz or 160+160 MHz BW PPDU respectively. The 242-tone RU index i, ranged between 1 to 16, can be used to represent the respective frequency-domain positions of the 242-tone RUs, i.e. 242-tone RU1 to RU16, within the 320 MHz or 160+160 MHz PPDU BW PPDU.

When a RUA subfield m (m =1 to 8) in an EHT-SIG CC n (n =1 or 2) indicates a 484-tone RU (RUA subfield value in a range of 136-143) is allocated for a 360 MHz or 160+160 MHz BW PPDU, the index j of the 484-tone RU indicated by the RUA subfield m in the EHT-SIG CC n can be determined based on the RUA subfield index m using the following equation (27):

$$j = m$$

where m is 1 to 8 referring to RUA1 to RUA8 of each EHT-SIG CC in the 360 MHz or 160+160 MHz BW PPDU respectively. The 484-tone RU index j, ranged between 1 to 8, can be used to represent the respective frequency-domain positions of the 484-tone RUs, i.e. 484-tone RU1 to RU8, within the 320 MHz or 160+160 MHz PPDU BW PPDU.

When a RUA subfield m (m =1 to 8) in an EHT-SIG CC n (n =1 or 2) indicates a RU combination of one 484-tone RU and one 242-tone RU (RUA subfield value in a range of 144-151) is allocated for a 360 MHz or 160+160 MHz BW PPDU, the index i of the 242-tone RU of the RU combination indicated by the RUA subfield m in the EHT-SIG CC n can be determined based on the EHT-SIG CC index n and the RUA subfield index m using the following equation (28); while the index j of the 484-tone RU of the RU combination indicated by the RUA subfield m in the EHT-SIG CC n can be determined based on the RUA subfield index m using the following equation (29):

$$i = 8 \times c e i l \left(\frac{m}{2}\right) - 2 m + n - 4$$

$$j = m$$

where n is 1 to 2 referring to EHT-SIG CC1 and CC2 respectively, and m is 1 to 8 referring to RUA1 to RUA8 of each EHT-SIG CC in the 360 MHz or 160+160 MHz BW PPDU respectively. The 242-tone RU index i, ranged between 1 to 16, can be used to represent the respective frequency-domain positions of the 242-tone RUs, i.e. 242-tone RU1 to RU16, within the 320 MHz or 160+160 MHz PPDU BW PPDU. The 484-tone RU index j, ranged between 1 to 8, can be used to represent the respective frequency-domain positions of the 484-tone RUs, i.e. 484-tone RU1 to RU8, within the 320 MHz or 160+160 MHz PPDU BW PPDU.

When a RUA subfield m (m =1 to 8) in an EHT-SIG CC n (n =1 or 2) indicates a 996-tone RU (RUA subfield value in a range of 152-159) is allocated for a 360 MHz or 160+160 MHz BW PPDU, the index k of the 996-tone RU indicated by the RUA subfield m in the EHT-SIG CC n can be determined based on the RUA subfield index m using the following equation (30):

$$k = c e i l \left(\frac{m}{2}\right)$$

where m is 1 to 8 referring to RUA1 to RUA8 of each EHT-SIG CC in the 360 MHz or 160+160 MHz BW PPDU respectively. The 996-tone RU index k, ranged between 1 to 4, can be used to represent the respective frequency-domain positions of the 996-tone RUs, i.e. 996-tone RU1 to RU4, within the 320 MHz or 160+160 MHz PPDU BW PPDU.

When a RUA subfield m (m =1 to 8) in an EHT-SIG CC n (n=1 or 2) indicates a RU combination of one 996-tone RU and one 484-tone RU (RUA subfield value in a range of 160-167) is allocated for 360 MHz or 160+160 MHz BW PPDU, the index j of the component 484-tone RU and the index k of the component 996-tone RU of the RU combination indicated by the RUA subfield m in the EHT-SIG CC n can be determined based on the RUA subfield index m using the following equations (31) and (32) respectively:

$$j = m - 4 \times c e i l \left(\frac{m}{2}\right) + 8 \times f l o o r \left(\frac{m}{5}\right) + 6$$

$$k = c e i l \left(\frac{m}{2}\right)$$

where m is 1 to 8 referring to RUA1 to RUA8 of each EHT-SIG CC in the 360 MHz or 160+160 MHz BW PPDU respectively. The 484-tone RU index j, ranged between 1 to 8, can be used to represent the respective frequency-domain positions of the 484-tone RUs, i.e. 484-tone RU1 to RU8, within the 320 MHz or 160+160 MHz PPDU BW PPDU. The 996-tone RU index k, ranged between 1 to 4, can be used to represent the respective frequency-domain positions of the 996-tone RUs, i.e. 996-tone RU1 to RU4, within the 320 MHz or 160+160 MHz PPDU BW PPDU.

When a RUA subfield m (m = 1 to 8) in an EHT-SIG CC n (n=1 or 2) indicates a RU combination of two 996-tone RUs (RUA subfield value in a range of 168-175) is allocated for a 360 MHz or 160+160 MHz BW PPDU, the index k₁ of the first component 996-tone RU and the index k₂ of the second component 996-tone RU of the RU combination indicated by the RUA subfield m in the EHT-SIG CC n can be determined based on the RUA subfield index m using the following equations (33) and (34) respectively:

$${k}_{1} = c e i l \left(\frac{m}{4}\right) + f l o o r \left(m / 5\right)$$

$${k}_{2} = {k}_{1} + 1$$

where m is 1 to 8 referring to RUA1 to RUA8 of each EHT-SIG CC in the 360 MHz or 160+160 MHz BW PPDU respectively and the function floor(x) denotes the greatest integer less than or equal to x. The 996-tone RU index k₁ or k₂, ranged between 1 to 4, can be used to represent the respective frequency-domain positions of the 996-tone RUs, i.e. 996-tone RU1 to RU4, within the 320 MHz or 160+160 MHz PPDU BW PPDU.

When a RUA subfield m (m = 1 to 8) in an EHT-SIG CC n (n=1 or 2) indicates a RU combination of two 996-tone RUs and one 484-tone RU (RUA subfield value in a range of 176-183) is allocated for a 360 MHz or 160+160 MHz BW PPDU, the index j of the component 484-tone RU, the index k₁ of the first component 996-tone RU and the index k₂ of the second component 996-tone RU of the RU combination indicated by the RUA subfield m in the EHT-SIG CC n can be determined based on the RUA subfield index m using the following equations (35). (36) and (37) respectively:

$$j = m - 6 \times c e i l \left(\frac{m}{4}\right) + 2 \times f l o o r \left(m / 5\right) + 10$$

$$k 1 = c e i l \left(\frac{m}{4}\right) + f l o o r \left(\frac{m}{5}\right)$$

$$k 2 = k 1 + 1$$

where m is 1 to 8 referring to RUA1 to RUA8 of each EHT-SIG CC in the 360 MHz or 160+160 MHz BW PPDU respectively. The 484-tone RU index j, ranged between 1 to 8, can be used to represent the respective frequency-domain positions of the 484-tone RUs, i.e. 484-tone RU1 to RU8, within the 320 MHz or 160+160 MHz PPDU BW PPDU. The 996-tone RU index k₁ or k₂, ranged between 1 to 4, can be used to represent the respective frequency-domain positions of the 996-tone RUs, i.e. 996-tone RU1 to RU4, within the 320 MHz or 160+160 MHz PPDU BW PPDU.

When a RUA subfield m (m=1 to 8) in an EHT-SIG CC n (n=1 or 2) indicates a RU combination of three 996-tone RUs (RUA subfield value in a range of 184-191) is allocated for a 360 MHz or 160+160 MHz BW PPDU, the index k₁ of the first component 996-tone RU, the index k₂ of the second component 996-tone RU and the index k₃ of the third component 996-tone RU of the RU combination indicated by the RUA subfield m in the EHT-SIG CC n can be determined based on the RUA subfield index m using the following equations (38). (39) and (40) respectively:

$${k}_{1} = c e i l \left(\frac{m}{4}\right) + f l o o r \left(m / 5\right)$$

$${k}_{2} = {k}_{1} + 1$$

$${k}_{3} = {k}_{1} + c e i l \left(\frac{m}{2}\right) - 5 \times f l o o r \left(m / 5\right)$$

where m is 1 to 8 referring to RUA1 to RUA8 of each EHT-SIG CC in the 360 MHz or 160+160 MHz BW PPDU respectively. The 996-tone RU index k₁, k₂ or k₃ ranged between 1 to 4, can be used to represent the respective frequency-domain positions of the 996-tone RUs, i.e. 996-tone RU1 to RU4, within the 320 MHz or 160+160 MHz PPDU BW PPDU.

When a RUA subfield m (m=1 to 8) in an EHT-SIG CC n (n=1 or 2) indicates a RU combination of three 996-tone RUs and one 484-tone RU (RUA subfield value in a range of 176-183) is allocated for a 360 MHz or 160+160 MHz BW PPDU, the index j of the component 484-tone RU, the index k₁ of the first component 996-tone RU, the index k₂ of the second component 996-tone RU and the index k₃ of the third component 996-tone RU of the RU combination indicated by the RUA subfield m in the EHT-SIG CC n can be determined based on the RUA subfield index m using the following equations (41), (42), (43) and (44) respectively:

$$j = m - 2 \times c e i l \left(\frac{m}{2}\right) - 2 \times f l o o r \left(m / 5\right) + 8$$

$${k}_{1} = c e i l \left(\frac{m}{4}\right) + f l o o r \left(\frac{m}{5}\right)$$

$${k}_{2} = {k}_{1} + 1$$

$${k}_{3} = {k}_{1} + c e i l \left(\frac{m}{2}\right) - 5 \times f l o o r \left(m / 5\right)$$

where m is 1 to 8 referring to RUA1 to RUA8 of each EHT-SIG CC in the 360 MHz or 160+160 MHz BW PPDU respectively. The 484-tone RU index j, ranged between 1 to 8, can be used to represent the respective frequency-domain positions of the 484-tone RUs, i.e. 484-tone RU1 to RU8, within the 320 MHz or 160+160 MHz PPDU BW PPDU. The 996-tone RU index k₁, k₂ or k₃ ranged between 1 to 4, can be used to represent the respective frequency-domain positions of the 996-tone RUs, i.e. 996-tone RU1 to RU4, within the 320 MHz or 160+160 MHz PPDU BW PPDU.

According to various embodiments of the present disclosure, based on the mapping of frequency-domain positions of various large-size RU and RU combinations in 80 MHz, 160 MHz (or 80+80 MHz), 240 MHz (or 160+80 MHz) and 360 MHz (or 160+160 MHz), there are several observations. For any PPDU BW equal to or larger than 80 MHz, frequency-domain positions of component RUs of a RU combination comprising one 484-tone RU and one 242-tone RU depends on RU allocation subfield index and EHT-SIG CC index. For a PPDU BW that is one of 160 MHz, 80+80 MHz, 320 MHz and 160+160 MHz, frequency-domain positions of component RUs of a RU combination comprising one 996-tone RU and one 484-tone RU depend on RU allocation subfield index and does not depend on EHT-SIG CC index. However, for a PPDU BW that is 240 MHz or 160+80 MHz, frequency-domain positions of component RUs of a RU combination comprising one 996-tone RU and one 484-tone RU depend on both RU allocation subfield index and EHT-SIG CC index. For a PPDU BW that is one of 240 MHz, 160+80 MHz, 320 MHz and 160+160 MHz, frequency-domain positions of component RUs of a RU combination comprising two 996-tone RUs depend on RU allocation subfield index and does not depend on EHT-SIG CC index. For a PPDU BW that is 320 MHz or 160+160 MHz, frequency-domain positions of component RUs of a RU combination comprising two 996-tone RUs and one 484-tone RU depend on RU allocation subfield index. However, for a PPDU BW that is 240 MHz or 160+80 MHz, frequency-domain positions of component RUs of a RU combination comprising two 996-tone RUs and one 484-tone RU depend on both RU allocation subfield index and EHT-SIG CC index. For a PPDU BW that is 320 MHz or 160+160 MHz, frequency-domain positions of component RUs of a RU combination comprising three 996-tone RUs or a RU combination comprising three 996-tone RUs and one 484-tone RU depend on RU allocation subfield index.

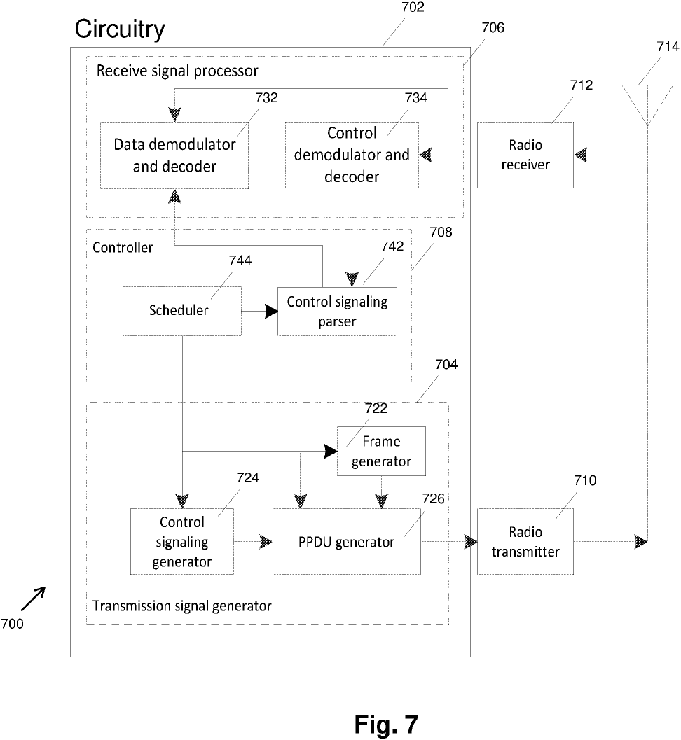

FIG. 7 shows a configuration of a communication device 700, for example an AP according to various embodiments. Similar to the schematic example of the communication apparatus 400 shown in FIG. 4, the communication apparatus 700 includes circuitry 702, at least 714 radio transmitter 710, at least one radio receiver 712, at least one antenna 714 (for the sake of simplicity, only one antenna is depicted in FIG. 7). The circuitry 702 may include at least one controller 708 for use in software and hardware aided execution of tasks that the controller 708 is designed to perform OFDMA or non-OFDMA communications. The circuitry 702 may further include a transmission signal generator 704 and a receive signal processor 706. The at least one controller 708 may control the transmission signal generator 704 and the receive signal processor 706. The transmission signal generator 704 may include a frame generator 722, a control signaling generator 724, and a PPDU generator 726. The frame generator 722 may generate MAC frames, e.g. data frames or triggering frames. The control signaling generator 724 may generate control signalling fields of PPDUs to be generated (e.g. U-SIG fields and EHT-SIG fields of EHT basic PPDUs). The PPDU generator 726 may generate PPDUs (e.g. EHT basic PPDUs).

The receive signal processor 706 may include a data demodulator and decoder 734, which may demodulate and decode data portions of the received signals (e.g. data fields of EHT basic PPDUs). The receive signal processor 706 may further include a control demodulator and decoder 734, which may demodulate and decode control signalling portions of the received signals (e.g. U-SIG fields and EHT-SIG fields of EHT basic PPDUs). The at least one controller 708 may include a control signal parser 742 and a scheduler 744. The scheduler 744 may determine RU information and user-specific allocation information for allocations of downlink SU or MU transmissions and triggering information for allocations of uplink MU transmissions. The control signal parser 742 may analyse the control signalling portions of the received signals and the triggering information for allocations of uplink MU transmissions shared by the scheduler 944 and assist the data demodulator and decoder 732 in demodulating and decoding the data portions of the received signals.

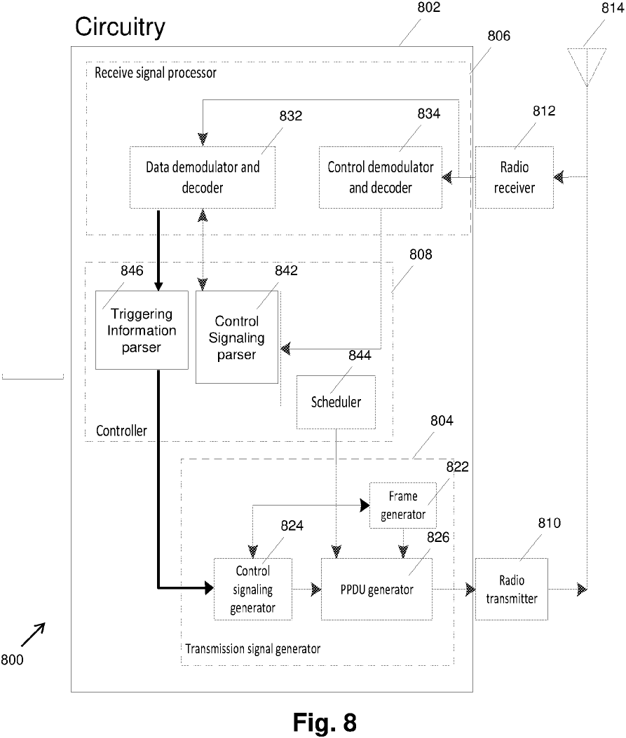

FIG. 8 shows a configuration of a communication apparatus 800, for example a STA according to various embodiments. Similar to the schematic example of communication apparatus 400 shown in FIG. 4, the communication apparatus 800 includes circuitry 802, at least one radio transmitter 810, at least one radio receiver 812, at least one antenna 814 (for the sake of simplicity, only one antenna is depicted in FIG. 8). The circuitry 802 may include at least one controller 808 for use in software and hardware aided execution of tasks that the controller 808 is designed to perform OFDMA or non-OFDMA communications. The circuitry 802 may further include a receive signal processor 804 and a transmission signal generator 806. The at least one controller 808 may control the receive signal processor 804 and the transmission signal generator 806. The receive signal processor 804 may include a data demodulator and decoder 832 and a control demodulator and decoder 834. The control demodulator and decoder 834 may demodulate and decode control signalling portions of the received signals (e.g. U-SIG fields and EHT-SIG fields of EHT basic PPDUs). The data demodulator and decoder 832 may demodulate and decode data portions of the received signals (e.g. data fields of ETH basic PPDUs) according to RU information and user-specific allocation information of its own allocations.

The at least one controller 808 may include a control signal parser 842, and a scheduler 844 and a trigger information parser 846. The control signal parser 842 may analyse the control signaling portions of the received signals (e.g. U-SIG fields and EHT-SIG fields of EHT basic PPDUs) and assist the data demodulator and decoder 832 in demodulating and decoding the data portions of the received signals (e.g. data fields of EHT basic PPDUs). The triggering information parser 848 may analyse the triggering information for its own uplink allocations from the received triggering frames contained in the data portions of the received signals. The transmission signal generator 804 may include a control signalling generator 824, which may generate control signalling fields of PPDUs to be generated (e.g. U-SIG fields of EHT basic PPDUs). The transmission signal generator 804 may further include a PPDU generator 826, which generate PPDUs (e.g. EHT basic PPDUs). The transmission signal generator 804 may further include a frame generator 822 may generate MAC frames, e.g. data frames.

As described above, the embodiments of the present disclosure provide an advanced communication system, communication methods and communication apparatuses for MU-MIMO transmissions in WLAN networks of an extremely high throughput and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (loT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

TABLE 1

RU allocation subfield values corresponding to assignments of small-size RU according to an embodiment

| | | | | | | | | | | |
|---|---|---|---|---|---|---|---|---|---|---|
| B7....B1B0 | #1 | #2 | #3 | #4 | #5 | #6 | #7 | #8 | #9 | #of Entries |
| 0 (“00000000”) | 26 | 26 | 26 | 26 | 26 | 26 | 26 | 26 | 26 | 1 |
| 1 (“00000001”) | 26 | 26 | 26 | 26 | 26 | 26 | 26 | 52 | | 1 |
| 2 (“00000010”) | 26 | 26 | 26 | 26 | 26 | 52 | | 26 | 26 | 1 |
| 3 (“00000011”) | 26 | 26 | 26 | 26 | 26 | 52 | | 52 | | 1 |
| 4 (“00000100”) | 26 | 26 | 52 | | 26 | 26 | 26 | 26 | 26 | 1 |
| 5 (“00000101”) | 26 | 26 | 52 | | 26 | 26 | 26 | 52 | | 1 |
| 6 (“00000110”) | 26 | 26 | 52 | | 26 | 52 | | 26 | 26 | 1 |
| 7 (“00000111”) | 26 | 26 | 52 | | 26 | 52 | | 52 | | 1 |
| 8 (“00001000”) | 52 | | 26 | 26 | 26 | 26 | 26 | 26 | 26 | 1 |
| 9 (“00001001”) | 52 | | 26 | 26 | 26 | 26 | 26 | 52 | | 1 |
| 10 (“00001010”) | 52 | | 26 | 26 | 26 | 52 | | 26 | 26 | 1 |
| 11 (“00001011”) | 52 | | 26 | 26 | 26 | 52 | | 52 | | 1 |
| 12 (“00001100”) | 52 | | 52 | | 26 | 26 | 26 | 26 | 26 | 1 |
| 13 (“00001101”) | 52 | | 52 | | 26 | 26 | 26 | 52 | | 1 |
| 14 (“00001110”) | 52 | | 52 | | 26 | 52 | | 26 | 26 | 1 |
| 15 (“00001111”) | 52 | | 52 | | 26 | 52 | | 52 | | 1 |
| 16 (“00010000”) | 26 | 26 | 26 | 26 | 26 | 106 | | | | 1 |
| 17 (“00010001”) | 26 | 26 | 52 | | 26 | 106 | | | | 1 |
| 18 (“00010010”) | 52 | | 26 | 26 | 26 | 106 | | | | 1 |
| 19 (“00010011”) | 52 | | 52 | | 26 | 106 | | | | 1 |
| 20 (“00010100”) | 106 | | | | 26 | 26 | 26 | 26 | 26 | 1 |
| 21 (“00010101”) | 106 | | | | 26 | 26 | 26 | 52 | | 1 |
| 22 (“00010110”) | 106 | | | | 26 | 26 | 26 | 52 | 26 | 1 |
| 23 (“00010111”) | 106 | | | | 26 | 52 | | 52 | | 1 |
| 24 (“00011000”) | 52 | | 52 | | - | 52 | | 52 | | 1 |
| 25 (“00011001”) | 106 | | | | 26 | 106 | | | | 1 |
| 26∼31 (“00011010″∼“00011111”) | reserved | | | | | | | | | 7 |

TABLE 2

RU allocation subfield values corresponding to assignment of small-size RU combinations according to an embodiment

| | | | | | | | | | | |
|---|---|---|---|---|---|---|---|---|---|---|
| B7...B1B0 | #1 | #2 | #3 | #4 | #5 | #6 | #7 | #8 | #9 | # of Entries |
| 32 (“00100000”) | 26 | 26+52 | | | 26 | 26 | 26 | 26 | 26 | 1 |
| 33 (“00100001”) | 26 | 26+52 | | | 26 | 26 | 26 | 52 | | 1 |
| 34 (“00100010”) | 26 | 26+52 | | | 26 | 52 | | 26 | 26 | 1 |
| 35 (“00100011”) | 26 | 26+52 | | | 26 | 52 | | 52 | | 1 |
| 36 (“00100100”) | 26 | 26 | 26 | 26 | 26 | 52+26 | | | 26 | 1 |
| 37 (“00100101”) | 52 | | 26 | 26 | 26 | 52+26 | | | 26 | 1 |
| 38 (“00100110”) | 26 | 26 | 52 | | 26 | 52+26 | | | 26 | 1 |
| 39 (“00100111”) | 52 | | 52 | | 26 | 52+26 | | | 26 | 1 |
| 40 (“00101000”) | 26 | 26+52 | | | 26 | 52+26 | | | 26 | 1 |
| 41 (“00101001”) | 52 | | 52+26 | | | 52 | | 52 | | 1 |
| 42 (“00101010”) | 26 | 26+52 | | | 26 | 106 | | | | 1 |
| 43 (“00101011”) | 106 | | | | 26 | 52+26 | | | 26 | 1 |
| 44 (“00101100”) | 106+26 | | | | | 26 | 26 | 26 | 26 | 1 |
| 45 (“00101101”) | 106+26 | | | | | 26 | 26 | 52 | | 1 |
| 46 (“00101110”) | 106+26 | | | | | 52 | | 26 | 26 | 1 |
| 47 (“00101111”) | 106+26 | | | | | 52 | | 52 | | 1 |
| 48 (“00110000”) | 26 | 26 | 26 | 26 | 26+106 | | | | | 1 |
| 49 (“00110001”) | 52 | | 26 | 26 | 26+106 | | | | | 1 |
| 50 (“00110010”) | 26 | 26 | 52 | | 26+106 | | | | | 1 |
| 51 (“00110011”) | 52 | | 52 | | 26+106 | | | | | 1 |
| 52 (“00110100”) | 26 | 26+52 | | | 26+106 | | | | | 1 |
| 53 (“00110101”) | 106+26 | | | | | 52+26 | | | 26 | 1 |
| 54 (“00110110”) | 106+26 | | | | | 106 | | | | 1 |
| 55 (“00110111”) | 106 | | | | 26+106 | | | | | 1 |
| 56 ~ 127 (“00111000”-“01111111”) | reserved | | | | | | | | | 72 |

TABLE 3

RU allocation subfield value corresponding to assignments of large-size RUs or RU combinations according to an embodiment

| | | | | | | | | | | |
|---|---|---|---|---|---|---|---|---|---|---|
| B7...B1B0 | #1 | #2 | #3 | #4 | #5 | #6 | #7 | #8 | #9 | # of Entries |
| 128^{∼} 135 (“10000y2y1y0”) | 242 | | | | | | | | | 8 |
| 136^{~} 143 (“10001y2y1y0”) | 484 | | | | | | | | | 8 |
| 144^{~} 151 (“10010y2y1y0”) | 242-tone RU+484-tone RU | | | | | | | | | 8 |
| 152^{∼} 159 (“10011y2y1y0”) | 996 | | | | | | | | | 8 |
| 160^{∼} 167 (“10100y2y1y0”) | 484-tone RU+996-tone RU | | | | | | | | | 8 |
| 168^{∼} 175 (“10101y2y1y0”) | 2*996 | | | | | | | | | 8 |
| 176^{~} 183 (“10110y2y1y0”) | 2*996-tone RU+484-tone RU | | | | | | | | | 8 |
| 184^{~} 191 (“10111y2y1y0”) | 3*996 | | | | | | | | | 8 |
| 192^{~} 199 (“11000y2y1y0”) | 3*996-tone RU+484-tone RU | | | | | | | | | 8 |
| 200^{∼} 223 (“11001000″^{~}“11011111”) | reserved | | | | | | | | | 24 |
| 224 (“11100000”) | 242-tone RU empty (with zero users) | | | | | | | | | 1 |
| 225 (“11100001”) | 484-tone RU; contributes zero User fields to User Specific field in the same EHT-SIG content channel as this RU allocation subfield | | | | | | | | | 1 |
| 226 (“11100010”) | 484-tone RU+242-tone RU; contributes zero User fields to User Specific field in the same EHT-SIG content channel as this RU allocation subfield | | | | | | | | | 1 |
| 227 (“11100011”) | 996-tone RU; contributes zero User fields to User Specific field in the same EHT-SIG content channel as this RU allocation subfield | | | | | | | | | 1 |
| 228 (“11100100”) | 996-tone RUt-484-tone RU; contributes zero User fields to User Specific field in the same EHT-SIG content channel as this RU allocation subfield | | | | | | | | | 1 |
| 229 (“11100101”) | 2*996-tone RU; contributes zero User fields to User Specific field in the same EHT-SIG content channel as this RU allocation subfield | | | | | | | | | 1 |
| 230 (“11100110”) | 2*996-tone RU+484-tone RU; contributes zero User fields to User Specific field in the same EHT-SIG content channel as this RU allocation subfield | | | | | | | | | 1 |
| 231 (“11100111”) | 3*996-tone RU; contributes zero User fields to User Specific field in the same EHT-SIG content channel as this RU allocation subfield | | | | | | | | | 1 |
| 232 (“11101000”) | 3*996-tone RU+484-tone RU; contributes zero User fields to User Specific field in the same EHT-SIG content channel as this RU allocation subfield | | | | | | | | | 1 |
| 233^{∼}25S (“11101100″^{~}“11111111”) | reserved | | | | | | | | | 23 |

TABLE 4

Mapping of frequency-domain positions of large-size RUs or RU combinations in an 80 MHz BW PPDU
80 MHz

| | | | | |
|---|---|---|---|---|
| RU type | CC1, RUA1 | CC2, RUA1 | CC1, RUA2 | CC2, RUA2 |
| 242-tone RU | 242-tone RU1 | 242-tone RU2 | 242-tone RU3 | 242-tone RU4 |
| 484-tone RU | 484-tone RU1 | | 484-tone RU2 | |
| 484-tone RU + 242-tone RU | 484-tone RU1, 242-tone RU3 | 484-tone RU1, 242-tone RU4 | 484-tone RU2, 242-tone RU1 | 484-tone RU2, 242-tone RU2 |

TABLE 5

Mapping of frequency-domain positions of large-size RUs or RU combinations in a 160 MHz or 80+80 MHz BW PPDU
160 MHz or 80+80 MHz

| | | | | | | | | |
|---|---|---|---|---|---|---|---|---|
| RU Type | CC1, RUA1 | CC2, RUA1 | CC1, RUA2 | CC2, RUA2 | CC1, RUA3 | CC2, RUA3 | CC1, RUA4 | CC2, RUA4 |
| 242-tone RU | 242-tone RU1 | 242-tone RU2 | 242-tone RU3 | 242-tone RU4 | 242-tone RU5 | 242-tone RU6 | 242-tone RU7 | 242-tone RU8 |
| 484-tone RU | 484-tone RU1 | | 484-tone RU2 | | 484-tone RU3 | | 484-tone RU4 | |
| 484-tone RU + 242-tone RU | 484-tone RU1, 242-tone RU3 | 484-tone RU1, 242-tone RU4 | 484-tone RU2, 242-tone RU1 | 484-tone RU2, 242-tone RU2 | 484-tone RU3, 242-tone RU7 | 484-tone RU3, 242-tone RU8 | 484-tone RU4, 242-tone RU5 | 484-tone RU4, 242-tone RU6 |
| 996-tone RU | 996-tone RU1 | | | | 996-tone RU2 | | | |
| 996-tone RU + 484-tone RU | 996-tone RU1, 484-tone RU3 | | 996-tone RU1, 484-tone RU4 | | 996-tone RU2, 484-tone RU1 | | 996-tone RU2, 484-tone RU2 | |

TABLE 6

Mapping of frequency-domain positions of large-size RUs or RU combinations in a 240 MHz or 160+80 MHz BW PPDU
240 MHz or 160+80 MH_{Z}

| | | | | | | | | | | | | |
|---|---|---|---|---|---|---|---|---|---|---|---|---|
| RU type | CC1, RUA1 | CC2, RUA1 | CC1, RUA2 | CC2, RUA2 | CC1, RUA3 | CC2, RUA3 | CC1, RUA4 | CC2, RUA4 | CC1, RUAS | CC2, RUAS | CC1, RUA6 | CC2, RUA6 |
| 242-tone RU | 242-tone RU1 | 242-tone RU2 | 242-tone RU3 | 242-tone RU4 | 242-tone RU5 | 242-tone RU6 | 242-tone RU7 | 242-tone RU8 | 242-tone RU9 | 242-tone RU10 | 242-tone RU11 | 242-tone RU12 |
| 484-tone RU | 484-tone RU1 | | 484-tone RU2 | | 484-tone RU3 | | 484-tone RU4 | | 484-tone RU5 | | 484-tone RU6 | |
| 484-tone RU + 242-tone RU | 484-tone RU1, 242-tone RU3 | 484-tone RU1, 242-tone RU4 | 484-tone RU2, 242-tone RU1 | 484-tone RU2, 242-tone RU2 | 484-tone RU3, 242-tone RU7 | 484-tone RU3, 242-tone RU8 | 484-tone RU4, 242-tone RU5 | 484-tone RU4, 242-tone RU6 | 484-tone RU5, 242-tone RU11 | 484-tone RU5, 242-tone RU12 | 484-tone RU6, 242-tone RU9 | 484-tone RU6, 242-tone RU10 |
| 996-tone RU | 996-tone RU1 | | | | 996-tone RU2 | | | | 996-tone RU3 | | | |
| 996-tone RU + 484-tone RU | 996-tone 484-tone | RU1, RU3 | 996-tone 484-tone | RU1, RU4 | 996-tone RU2, 484-tone RU1 | 996-tone RU2, 484-tone RU2 | 996-tone RU2, 484-tone RU5 | 996-tone RU2, 484-tone RU6 | 996-tone RU3, 484-tone RU3 | | 996-tone RU3, 484-tone RU4 | |
| 2*996-tone RU | 996-tone RU1, 996-tone RU2 | | | | | | 996-tone RU2, 996-tone RU3 | | | | | |
| 2*996-tone RU + 484-tone RU | 996-tone RU1, 996-tone RU2, 484-tone RU5 | 996-tone RU1, 996-tone RU2, 484-tone RU6 | 996-tone RU1, 996-tone RU2, 484-tone RU5 | 996-tone RU1, 996-tone RU2, 484-tone RU6 | 996-tone RU1, 996-tone RU2, 484-tone RU5 | 996-tone RU1, 996-tone RU2, 484-tone RU6 | 996- tone RU2, 996- tone RU3, 484- tone RU1 | 996-tone RU2, 996-tone RU3, 484-tone RU2 | 996-tone RU2, 996-tone RU3, 484-tone RU1 | 996-tone RU2, 996-tone RU3, 484-tone RU2 | 996-tone RU2, 996-tone RU3, 484-tone RU1 | 996-tone RU2, 996-tone RU3, 484-tone RU2 |

TABLE 7

Mapping of frequency-domain positions of large-size RUs or RU combinations in a 320 MHz or 160+160 MHz BW PPDU
320 MHz or 160+16 OMHz

| | | | | | | | | |
|---|---|---|---|---|---|---|---|---|
| RU Type | CC1, RUA1 | CC2, RUA1 | CC1, RUA2 | CC2, RUA2 | CC1, RUA3 | CC2, RUA3 | CC1, RUA4 | CC2, RUA4 |
| 242-tone RU | 242-tone RU1 | 242-tone RU2 | 242-tone RU3 | 242-tone RU4 | 242-tone RU5 | 242-tone RU6 | 242-tone RU7 | 242-tone RU8 |
| 484-tone RU | 484-tone RU1 | | 484-tone RU2 | | 484-tone RU3 | | 484-tone RU4 | |
| 484-tone RU + 242-tone RU | 484-tone RU1, 242-tone RU3 | 484-tone RU1, 242-tone RU4 | 484-tone RU2, 242-tone RU1 | 484-tone RU2, 242-tone RU2 | 484-tone RU3, 242-tone RU7 | 484-tone RU3, 242-tone RU8 | 484-tone RU4, 242 -tone RU5 | 484-tone RU4, 242-tone RU6 |
| 996-tone RU | 996-tone RU1 | | | | 996-tone RU2 | | | |
| 996-tone RU + 484-tone RU | 996-tone RU1, 484-tone RU3 | | 996-tone RU1, 484-tone RU4 | | 996-tone RU2, 484-tone RU1 | | 996-tone RU2, 484-tone RU2 | |
| 2*996-tone RU | 996-tone RU1, 996-tone RU2 | | | | | | | |
| 2*996-tone RU + 484-tone RU | 996-tone RU1, 996-tone RU2, 484-tone RU5 | | 996-tone RU1. 996-tone RU2, 484-tone RU6 | | 996-tone RU1. 996-tone RU2, 484-tone RU7 | | 996-tone RU1, 996-tone RU2, 484-tone RU8 | |
| 3*996-tone RU | 996-tone RU1, 996-tone RU2, 996-tone RU3 | | | | 996-tone RU1, 996-tone RU2, 996-tone RU4 | | | |
| 3*996-tone RU + 484-tone RU | 996-tone RU1, 996-tone RU2, 996-tone RU3, 484-tone RU7 | | 996-tone RU1. 996-tone RU2. 996-tone RU3, 484-tone RU8 | | 996tone RU1, 996-tone RU2, 996-tone RU4, 484-tone RU5 | | 966-tone RU1, 996-tone RU2, \|996-tone RU4, 484-tone RU6 | |

320 MHz or 160+160 MHZ

| | | | | | | | | |
|---|---|---|---|---|---|---|---|---|
| RU Type | CC1, RUA5 | CC2, RUAS | CC1, RUA6 | CC2, RUA6 | CC1, RUA7 | CC2, RUA7 | CC1, RUA8 | CC2, RUA8 |
| 242-tone RU | 242-tone RU9 | 242-tone RU10 | 242-tone RU11 | 242-tone RU12 | 242-tone RU13 | 242-tone RU14 | 242-tone RU15 | 242-tone RU16 |
| 484-tone RU | 484-tone RU5 | | 484-tone RU6 | | 484-tone RU7 | | 484-tone RU8 | |
| 484-tone RU + 242-tone RU | 484-tone RU5, 242-tone RU11 | 484-tone RU5, 242-tone RU12 | 484-tone RU6, 242-tone RU9 | 484-tone RU6, 242-tone RU10 | 484-tone RU7, 242-tone RU15 | 484-tone RU7, 242-tone RU16 | 484-tone RU8, 242-tone RU13 | 484-tone RU8, 242-tone RU14 |
| 996-tone RU | 996-tone RU3 | | | | 996-tone RU4 | | | |
| 996-tone RU + 484-tone RU | 996-tone RU3, 484-tone RU7 | | 996-tone RU3, 484-tone RU8 | | 996-tone RU4,484-tone RU5 | | 996-tone RU4, 484-tone RU6 | |
| 2*996-tone RU | 996-tone RU3, 996-tone RU4 | | | | | | | |
| 2*996-tone RU + 484-tone RU | 996-tone RU3, 996-tone RU4, 484-tone RU1 | | 996-tone RU3, 996-tone RU4, 484-tone RU2 | | 996-tone RU3, 996-tone RU4, 484-tone RU3 | | 996-tone RU3, 996-tone RU4, 484-tone RU4 | |
| 3*996-tone RU | 996-tone RU1, 996-tone RU3, 996-tone RU4 | | | | 996-tone RU2, 996-tone RU3, 996-tone RU4 | | | |
| 3*996-tone RU + 484-tone RU | 996-tone RU1, 996-tone RU3, 996-tone RU4, 484-tone RU3 | | 996-tone RU1, 996-tone RU3, 996-tone RU4, 484-tone RU4 | | 996-tone RU2,996-tone RU3, 996-tone RU4,484-tone RU1 | | 996-tone RU2,996-tone RU3, 996-tone RU4, 484-tone RU2 | |

1. A communication apparatus, comprising:
circuitry, which, in operation, generates a physical layer protocol data unit (PPDU) comprising two signal field content channels in each 80 MHz frequency segment, each of the two signal field content channels comprising a plurality of resource unit (RU) allocation subfields, wherein a value of each of the plurality of RU allocation subfields is indicative of sizes of component RUs of a large-size RU combination; and
a transmitter, which, in operation, transmits the generated PPDU.

2. The communication apparatus according to claim 1, wherein a frequency position of the component RUs of the large-size RU combination is based on both of the value of each of the plurality of the RU allocation subfields and positions of each of the plurality of the RU allocation subfields in the two signal field content channels.

3. The communication apparatus according to claim 1, wherein for a PPDU bandwidth (BW) equal to or larger than 80 MHz frequency segment, frequency-domain positions of component RUs of the large-size RU combination depend on one of (i) a RU allocation subfield index, and (ii) the RU allocation subfield index and an EHT-SIG content channel (CC) index.

4. The communication apparatus according to claim 3, wherein the PPDU BW is equal to or larger than 80 MHz, and the large-size RU combination is a combination of one 484-tone RU and one 242-tone RU, the frequency-domain positions of components RUs of the large-size RU combination depend on the RU allocation subfield index and the EHT-SIG CC index.

5. The communication apparatus according to claim 3, wherein the PPDU BW is one of 160 MHz, 80+80 MHz, 320 MHz and 160+160 MHz, and the large-size RU combination is a combination of one 996-tone RU and one 484-tone RU, the frequency-domain positions of component RUs of the large-size RU combination depend on the RU allocation subfield index; wherein the PPDU BW is one of 240 MHz and 160+80 MHz, and the large-size RU combination is a combination of one 996-tone RU and one 484-tone RU, the frequency-domain positions of component RUs of the large-size RU combination depend on the RU allocation subfield index and the EHT-SIG CC index.

6. The communication apparatus according to claim 3, wherein the PPDU BW is one of 240 MHz, 160+80 MHz, 320 MHz and 160+160 MHz, and the large-size RU combination is a combination of two 996-tone RUs, the frequency-domain positions of component RUs of the large-size RU combination depend on the RU allocation subfield index.

7. The communication apparatus according to claim 3, wherein the PPDU BW is 320 MHz or 160+160 MHz, and the large-size RU combination is a combination of two 996-tone RUs and one 484-tone RU, the frequency-domain positions of component RUs of the large-size RU combination depend on the RU allocation subfield index; wherein the PPDU BW is 240 MHz or 160+80 MHz, and the large-size RU combination is a combination of two 996-tone RUs and one 484-tone RU, the frequency-domain positions of component RUs of the large-size RU combination depend on the RU allocation subfield index and the EHT-SIG CC index.

8. The communication apparatus according to claim 3, wherein the PPDU BW is 320 MHz or 160+160 MHz and the large-size RU combination is one of a combination of three 996-tone RUs or a combination of three 996-tone RUs and one 484-tone RU, the frequency-domain positions of component RUs of the large-size RU combination depend on the RU allocation subfield index.

9. The communication apparatus according to claim 1, wherein a frequency position of the component RUs of the large-size RU combination is located within a defined 160 MHz segment.

10. A communication method comprising:
generating a physical layer protocol data unit (PPDU) comprising two signal field content channels in each 80 MHz frequency segment, each of the two signal field content channels comprising a plurality of resource unit (RU) allocation subfields, wherein a value of each of the plurality of RU allocation subfields is able to indicate sizes of component RUs of a large-size RU combination; and
transmitting the generated PPDU.

11. The communication method according to claim 10, wherein the value of each of the plurality of RU allocation subfields is not able to indicate information on frequency-domain positions of the component RUs of the large-size RU combination.

12. The communication method according to claim 10, wherein for a PPDU bandwidth (BW) equal to or larger than 80 MHz, frequency-domain positions of component RUs of the large-size RU combination depend on one of (i) a RU allocation subfield index, and (ii) the RU allocation subfield index and an EHT-SIG content channel (CC) index.

13. The communication method according to claim 12, wherein the PPDU BW is equal to or larger than 80 MHz, and the large-size RU combination is a combination of one 484-tone RU and one 242-tone RU, the frequency-domain positions of components RUs of the large-size RU combination depend on the RU allocation subfield index and the EHT-SIG CC index.

14. The communication method according to claim 12, wherein the PPDU BW is one of 160 MHz, 80+80 MHz, 320 MHz and 160+160 MHz, and the large-size RU combination is a combination of one 996-tone RU and one 484-tone RU, the frequency-domain positions of component RUs of the large-size RU combination depend on the RU allocation subfield index; wherein the PPDU BW is one of 240 MHz and 160+80 MHz, and the large-size RU combination is a combination of one 996-tone RU and one 484-tone RU, the frequency-domain positions of component RUs of the large-size RU combination depend on the RU allocation subfield index and the EHT-SIG CC index.

15. The communication method according to claim 12, wherein the PPDU BW is one of 240 MHz, 160+80 MHz, 320 MHz and 160+160 MHz, and the large-size RU combination is a combination of two 996-tone RUs, the frequency-domain positions of component RUs of the large-size RU combination depend on the RU allocation subfield index.

16. A communication apparatus, comprising:
a receiver, which, in operation, receives a physical layer protocol data unit (PPDU) comprising two signal field content channels in each 80 MHz frequency segment, each of the two signal field content channels comprising a plurality of resource unit (RU) allocation subfields, wherein a value of each of the plurality of RU allocation subfields is indicative of sizes of component RUs of a large-size RU combination; and
circuitry, which, in operations, decodes the PPDU.

17. The communication apparatus according to claim 16, wherein a frequency position of the component RUs of the large-size RU combination is based on both of the value of each of the plurality of the RU allocation subfields and positions of each of the plurality of the RU allocation subfields in the two signal field content channels.

18. The communication apparatus according to claim 16, wherein a frequency position of the component RUs of the large-size RU combination is located within a defined 160 MHz segment.
